(19) United States
(12) Patent Application Publication
(10) Pub. No.: US 2026/0164319 A1
(43) Pub. Date: Jun. 11, 2026

(54) CONFIGURING CANDIDATE CELL GROUPS

(71) Applicant: QUALCOMM Incorporated, San Diego, CA (US)

(72) Inventors: Karthika PALADUGU, Hyderabad (IN); Ozcan OZTURK, San Diego, CA (US); Naeem AKL, Bridgewater, NJ (US); Karl Georg HAMPEL, Jersey City, NJ (US); Gavin Bernard HORN, La Jolla, CA (US); Shankar KRISHNAN, Poway, CA (US)

(21) Appl. No.: 18/974,544

(22) Filed: Dec. 9, 2024

(51) Int. Cl. H04W 36/00

(52) U.S. Cl. CPC H04W 36/0069; H04W 36/0058

(57) ABSTRACT

Various aspects of the present disclosure generally relate to wireless communication. In some aspects, a user equipment (UE) may establish a dual connection with a network node that comprises a first connection via a first cell group and a second connection via a second cell group. The UE may receive, via at least one of the first connection or the second connection, a configuration for a third cell group, wherein the configuration for the third cell group indicates whether the third cell group is a candidate for changing the first cell group, for changing the second cell group, or for changing either the first cell group or the second cell group. The UE may perform a cell group change procedure to change the first cell group to the third cell group based at least in part on the configuration for the third cell group. Numerous other aspects are described.

### FIELD OF THE DISCLOSURE

Aspects of the present disclosure generally relate to wireless communication and specifically relate to techniques, apparatuses, and methods associated with configuring candidate cell groups.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some wireless communication networks, a network node may configure one or more cell groups to support communications with a user equipment (UE). In some cases, the network node may configure one or two active cell groups to support communications between the UE and the network node. For example, the network node may configure a first active master cell group and a second active secondary cell group to support dual connectivity for the UE. Additionally, the network node may configure one or more deactivated cell groups. For example, the network node may configure one or more deactivated secondary cell groups, one or more candidate secondary cell groups, or one or more candidate cell groups. For each configured cell group, the UE may perform measurement procedures, radio link monitoring, beam failure detection, or active communications based on whether a cell group is configured as an active master cell group, an active secondary cell group, a deactivated secondary cell group, a candidate secondary cell group, or a candidate cell group.

### SUMMARY

Some aspects described herein relate to a method of wireless communication performed by a user equipment (UE). The method may include establishing a dual connection with a network node, the dual connection comprising a first connection via a first cell group and a second connection via a second cell group. The method may include receiving, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group. The method may include performing a cell group change procedure to change the first cell group to the third cell group based at least in part on the configuration for the third cell group indicating that the third cell group is a candidate for changing the first cell group or for changing the first cell group and the second cell group.

Some aspects described herein relate to a method of wireless communication performed by a network node. The method may include establishing a dual connection with a UE, the dual connection comprising a first connection via a first cell group and a second connection via a second cell group. The method may include transmitting, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group. The method may include performing a cell group change procedure to change the first cell group to the third cell group based at least in part on the configuration for the third cell group indicating that the third cell group is a candidate for changing the first cell group or for changing the first cell group and the second cell group.

Some aspects described herein relate to an apparatus for wireless communication at a UE. The apparatus may include one or more memories and one or more processors coupled to the one or more memories. The one or more processors may be configured to establish a dual connection with a network node, the dual connection comprising a first connection via a first cell group and a second connection via a second cell group. The one or more processors may be configured to receive, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group. The one or more processors may be configured to perform a cell group change procedure to change the first cell group to the third cell group based at least in part on the configuration for the third cell group indicating that the third cell group is a candidate for changing the first cell group or for changing the first cell group and the second cell group.

Some aspects described herein relate to an apparatus for wireless communication at a network node. The apparatus may include one or more memories and one or more processors coupled to the one or more memories. The one or more processors may be configured to establish a dual connection with a UE, the dual connection comprising a first connection via a first cell group and a second connection via a second cell group. The one or more processors may be configured to transmit, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group. The one or more processors may be configured to perform a cell group change procedure to change the first cell group to the third cell group based at least in part on the configuration for the third cell group indicating that the third cell group is a candidate for changing the first cell group or for changing the first cell group and the second cell group.

Some aspects described herein relate to a non-transitory computer-readable medium that stores a set of instructions for wireless communication by a UE. The set of instructions, when executed by one or more processors of the UE, may cause the UE to establish a dual connection with a network node, the dual connection comprising a first connection via a first cell group and a second connection via a second cell group. The set of instructions, when executed by one or more processors of the UE, may cause the UE to receive, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group. The set of instructions, when executed by one or more processors of the UE, may cause the UE to perform a cell group change procedure to change the first cell group to the third cell group based at least in part on the configuration for the third cell group indicating that the third cell group is a candidate for changing the first cell group or for changing the first cell group and the second cell group.

Some aspects described herein relate to a non-transitory computer-readable medium that stores a set of instructions for wireless communication by a network node. The set of instructions, when executed by one or more processors of the network node, may cause the network node to establish a dual connection with a UE, the dual connection comprising a first connection via a first cell group and a second connection via a second cell group. The set of instructions, when executed by one or more processors of the network node, may cause the network node to transmit, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group. The set of instructions, when executed by one or more processors of the network node, may cause the network node to perform a cell group change procedure to change the first cell group to the third cell group based at least in part on the configuration for the third cell group indicating that the third cell group is a candidate for changing the first cell group or for changing the first cell group and the second cell group.

Some aspects described herein relate to an apparatus for wireless communication. The apparatus may include means for establishing a dual connection with a network node, the dual connection comprising a first connection via a first cell group and a second connection via a second cell group. The apparatus may include means for receiving, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group. The apparatus may include means for performing a cell group change procedure to change the first cell group to the third cell group based at least in part on the configuration for the third cell group indicating that the third cell group is a candidate for changing the first cell group or for changing the first cell group and the second cell group.

Some aspects described herein relate to an apparatus for wireless communication. The apparatus may include means for establishing a dual connection with a UE, the dual connection comprising a first connection via a first cell group and a second connection via a second cell group. The apparatus may include means for transmitting, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group. The apparatus may include means for performing a cell group change procedure to change the first cell group to the third cell group based at least in part on the configuration for the third cell group indicating that the third cell group is a candidate for changing the first cell group or for changing the first cell group and the second cell group.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3 through 5 are diagrams illustrating example wireless communication networks, in accordance with the present disclosure.

FIGS. 6A and 6B are diagrams illustrating examples of cell group set configurations, in accordance with the present disclosure.

FIG. 7 is a diagram illustrating an example of a candidate cell group configuration, in accordance with the present disclosure.

FIGS. 8-10 are diagrams illustrating associated with configuring candidate cell groups, in accordance with the present disclosure.

FIG. 11 is a diagram illustrating an example process performed, for example, at a user equipment (UE) or an apparatus of a UE, in accordance with the present disclosure.

FIG. 12 is a diagram illustrating an example process performed, for example, at a network node or an apparatus of a network node, in accordance with the present disclosure.

FIGS. 13 and 14 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, a network node may configure one or more cell groups to support communications with a UE. For example, the network node may configure one or more active cell groups to support communications between the UE and the network node. In some cases, the active cell group may correspond to an active master cell group or an active secondary cell group. That is, the network node may configure a first active master cell group and a second active secondary cell group to support dual connectivity for the UE. Additionally, the network node may configure one or more deactivated cell groups. For example, the network node may configure one or more deactivated secondary cell groups (e.g., for dual connectivity), one or more candidate secondary cell groups (e.g., for a conditional handover procedure), or one or more candidate cell groups (e.g., for lower layer triggered mobility procedures). For each configured cell group, the UE may perform measurement procedures, radio link monitoring, beam failure detection, or active communications based on whether a cell group is configured as an active master cell group, an active secondary cell group, a deactivated secondary cell group, a candidate secondary cell group, or a secondary cell group.

To configure the various types of cell groups (e.g., an active master cell group, an active secondary cell group, a deactivated secondary cell group, a candidate secondary cell group, a secondary cell group), the network node may additionally configure one or more resources (e.g., layer 1 (L1) and/or layer 2 resources) for the bearers for communications via that cell group. The network node may configure the resources for the bearers based on the type of cell group. For example, the network node may configure the resources for secondary cell groups to include the resources for the secondary cell group radio bearers. Additionally, the network node may configure the resources for conditional handover and lower layer triggered mobility procedure cell groups to include the resources for all of the bearers. In some cases, the network node may indicate the cell group configurations via a radio resource control (RRC) reconfiguration message that indicates a full configuration for the cell group or that indicates a delta configuration (e.g., by indicating a difference between the configuration for the cell group and a predefined cell group configuration).

In some other wireless communication networks, a UE may be capable of communicating with a network node via multiple cell groups without one of the cell groups being configured as a master cell group and another one of the cell groups being configured as a secondary cell group. For example, the UE may be communicating with a network node that includes a central unit (CU) via two cell groups: a first cell group that is associated with a first distributed unit (DU) and a second cell group that is associated with a second DU. In some cases, both the first and second DUs may be associated with (e.g., controlled by) the single network node including the CU (e.g., an anchor CU). Accordingly, the CU may coordinate communications between the first and second DUs (e.g., rather than one of the DUs being associated with a master cell group that coordinates communications for the master cell group and the secondary cell group).

When the UE is capable of communicating with the CU via multiple cell groups without a master cell group and one or more secondary cell groups, the network node may configure cell groups independently of whether a UE subsequently uses the cell groups for mobility procedures or dual connectivity. That is, because the network node does not configure different types of cell groups to be specific for specific types of procedures, a configured candidate cell group may subsequently be used for dual connectivity, for a conditional handover, for a lower layer triggered mobility procedure, or for some other type of procedure. Accordingly, the network node may not configure the resources associated with a cell group in accordance with a specific type of procedure. Instead, the network node may configure dedicated candidate cell group sets and, optionally, a shared candidate cell group set. A dedicated candidate cell group set may include one or more cell groups that are each configured with a same set of bearer resources (e.g., bearer L2/L1 resources). Here, each active cell group may be associated with a dedicated candidate cell group set, and a UE may be configured to perform handover procedures between any cell group in a dedicated candidate cell group set. That is, a candidate cell group in a dedicated candidate cell group set may be a candidate for changing an active cell group from the same dedicated candidate cell group set. Additionally, to support dual connectivity, the UE may establish a first connection with a network node using one cell group from a first dedicated candidate cell group set and another cell group from a second dedicated candidate cell group set. That is, the UE may not be configured to establish two or more connections that are associated with cell groups in a same dedicated candidate cell group set.

Additionally, a shared candidate cell group set may include one or more cell groups that are configured to be shared between multiple active cell groups. For example, a UE may perform a handover from either a first active cell group or a second active cell group to a third cell group within a shared candidate cell group set. That is, the third cell group within the shared candidate cell group set may be a candidate for changing either the first activate cell group or the second active cell group. A network node may configure resources associated with each of the bearers configured for the UE for cell groups within a shared candidate cell group set. Then, the network node may dynamically activate or deactivate the set of resources configured for a shared candidate cell group when the candidate cell group is activated (e.g., based on whether the candidate cell group is activated for dual connectivity or a mobility procedure, based on one or more other cell groups that are activated).

Particular aspects of the subject matter described in this disclosure can be implemented to realize one or more of the following potential advantages. In some examples, the described techniques can be used to simplify a configuration of cell groups. That is, by reducing a quantity of cell group configuration types (e.g., from active master cell groups, active secondary cell groups, deactivated secondary cell groups, candidate secondary cell groups, and candidate cell groups to active cell groups and deactivated cell groups associated with dedicated candidate cell group sets or shared candidate cell group sets), a complexity of the signaling associated with configuring cell groups may be decreased, thus improving a latency associated with configuring one or more cell groups. Additionally, reducing the quantity of cell group configuration types may further improve a flexibility of cell group configurations. That is, the network node may configure a single cell group that is capable of supporting more functionality, which may further improve communication efficiency. Further, the configuration of cell groups to be within dedicated cell group sets or within shared cell group sets may reduce signaling overhead associated with subsequent procedures related to the cell groups. For example, there may be a reduction in signaling overhead for mobility procedures and handover procedures based on configuring the cell groups to be within the dedicated cell group sets or shared cell group sets.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

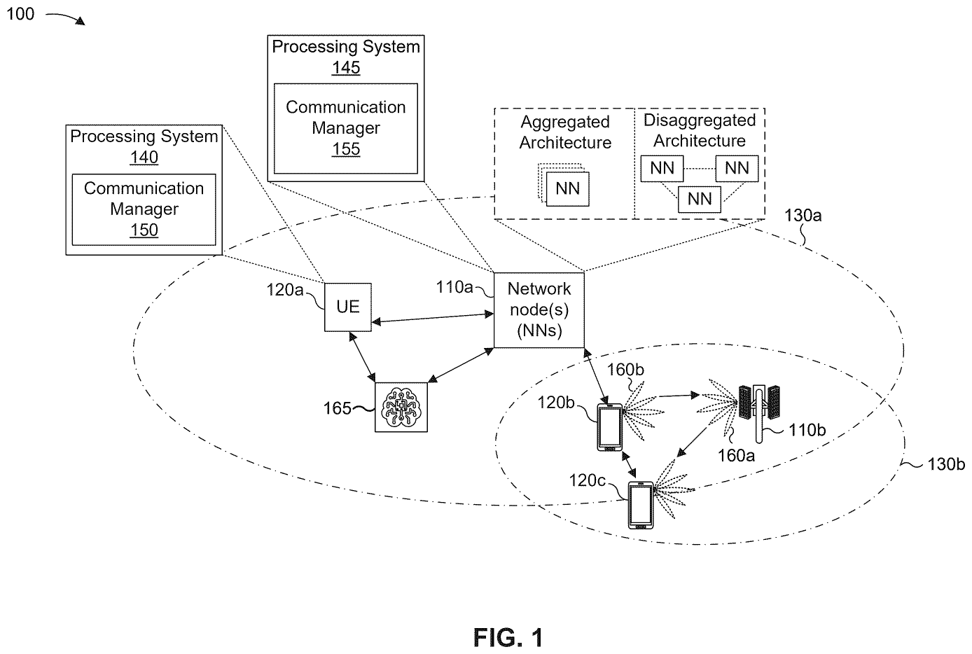

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

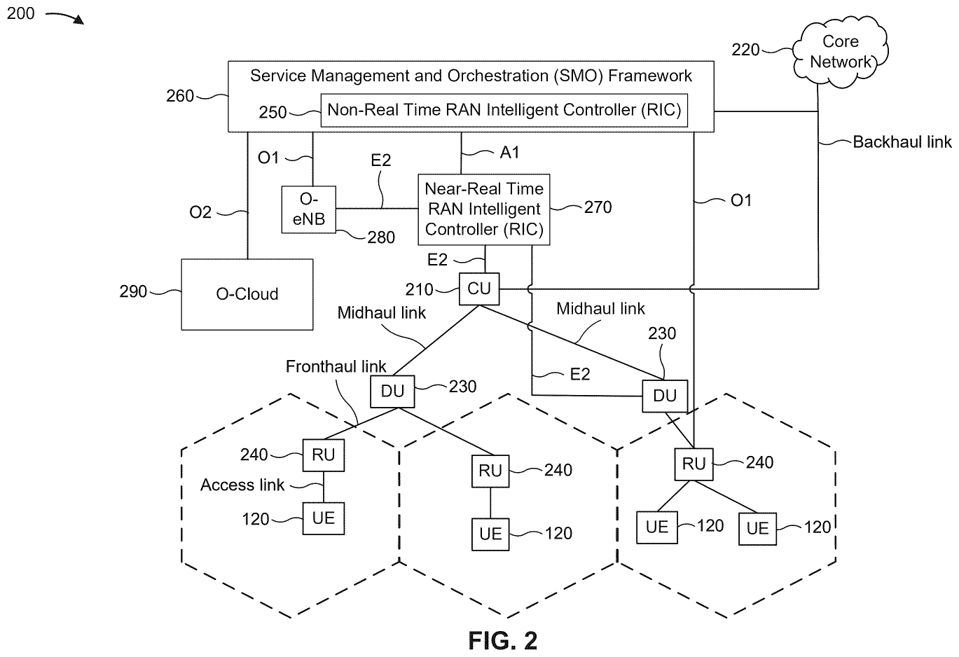

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, an L1-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi-co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may establish a dual connection with a network node, the dual connection comprising a first connection via a first cell group and a second connection via a second cell group; receive, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group; and perform a cell group change procedure to change the first cell group to the third cell group based at least in part on the configuration for the third cell group indicating that the third cell group is a candidate for changing the first cell group or for changing the first cell group and the second cell group. Additionally, or alternatively, the communication manager 150 may perform one or more other operations described herein.

In some aspects, the network node 110 may include a communication manager 155. As described in more detail elsewhere herein, the communication manager 155 may establish a dual connection with a UE, the dual connection comprising a first connection via a first cell group and a second connection via a second cell group; transmit, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group; and perform a cell group change procedure to change the first cell group to the third cell group based at least in part on the configuration for the third cell group indicating that the third cell group is a candidate for changing the first cell group or for changing the first cell group and the second cell group. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

In some examples, the disaggregated network node architecture 200 may be associated with a 5G core network. For example, the DUs 230 and the CUs 210 may be associated with a 5G core network. In such examples, the CUs 210 and DUs 230 may be associated with a functional split. That is, the CUs 210 may perform UE-related tasks such as radio bearer management and UE mobility. The CUs 210 may interface to the UE 120 via RRC connections and may interface to the DUs 230 via an F1 interface (e.g., an F1-C interface). Further, the CUs 210 may interface with other CUs 210 via an Xn interface. Additionally, in 5G core networks, the DUs 230 may manage radio resources of the cells (e.g., the cell groups 305). Further, the DUs 230 may exchange signaling with the UE 120 via MAC-CEs or PHY-layer signaling. In some examples of 5G networks, each CU 210 may be capable of interfacing with multiple DUs 230, but each DU 230 may only interface with a single CU 210. Accordingly, coordinating between DUs 230 that are associated with different CUs 210 may be complex, as the different CUs 210 may in turn coordinate bearer management across both DUs 230.

As a result of this complexity, 5G core networks may rely on master nodes and secondary nodes to support dual connectivity. The dual connectivity may correspond to an Evolved Universal Mobile Telecommunications System Terrestrial Radio Access (E-UTRA)-NR dual connectivity (ENDC) mode. In the ENDC mode, a UE 120 communicates using an LTE RAT on a master cell group, and the UE 120 communicates using an NR RAT on a secondary cell group. Additionally, the dual connectivity may correspond to an NR-E-UTRA dual connectivity (NEDC) mode (e.g., where the master cell group is associated with an NR RAT and the secondary cell group is associated with an LTE RAT), an NR dual connectivity (NRDC) mode (e.g., where the master cell group is associated with an NR RAT and the secondary cell group is also associated with the NR RAT), or another dual connectivity mode (e.g., where the master cell group is associated with a first RAT and the secondary cell group is associated with one of the first RAT or a second RAT). The ENDC mode is sometimes referred to as an NR or 5G non-standalone (NSA) mode. Thus, as used herein, “dual connectivity mode” may refer to an ENDC mode, an NEDC mode, an NRDC mode, and/or another type of dual connectivity mode.

In some cases, the UE 120 may support two concurrent RRC connections (e.g., one via the master node and one via the secondary node) that are associated with separate security associations. When the wireless communication network includes master nodes and secondary nodes, if the UE 120 moves, a change of the master node may be coordinated separately from a change of the secondary node, which may result in increased signaling overhead (e.g., as compared to a change of the master node and secondary node that are coordinated together). Additionally, the procedures associated with different types of mobility procedures (e.g., a dual active protocol stack (DAPS) handover, a conditional handover, a lower layer triggered mobility procedure, a RACH-less handover) may be associated with different configurations and coordination, which may further increase signaling overhead and increase complexity.

There may be many different types of dual connectivity mobility procedures defined if the UE 120 is using two concurrent RRC connections via a master node and secondary node. The different types of dual connectivity mobility procedures may include a set of network-triggered mobility procedures. The set of network-triggered mobility procedures may include a secondary node addition procedure, a secondary node modification procedure, a secondary node change procedure, a secondary node release procedure, an inter-master-node handover with or without a secondary node change procedure, and an inter-master-node resume procedure without a secondary node change. The different types of dual connectivity mobility procedures may also include a set of UE triggered mobility procedures. The set of UE triggered mobility procedures may include a conditional secondary node or primary secondary cell addition procedure, a master node initiated conditional secondary node or primary secondary cell change procedure (e.g., an inter-secondary-node change procedure), a secondary node initiated conditional secondary node or primary secondary cell change (e.g., an inter-secondary-node or intra-secondary-node change procedure that does not include the master node), a conditional handover procedure with a secondary node addition or change or without a secondary node addition or change, a conditional handover with candidate cell groups (e.g., where the primary cell and primary secondary cell are moved together), and a subsequent cell packet access control (e.g., for inter-secondary node or intra-secondary node mobility scenarios).

In some cases of the disaggregated network node architecture 200, network nodes (such as DUs 230, CUs 210, or some other network node 110 associated with the core network 220) may configure various types of cell groups. For example, a network node may configure a master cell group, a deactivated secondary cell group, a candidate secondary cell group, a candidate cell group, and/or an activated secondary cell group. For each configured cell group, a UE 120 may perform measurement procedures, radio link monitoring, beam failure detection, or active communications based on a type of the configured cell group. An example of the various configurations for different types of cell groups is illustrated below in Table 1.

TABLE 1
Cell Group Type Configurations

| | Master | Deactivated | Candidate | |
|---|---|---|---|---|
| | Cell | Secondary | Secondary | Candidate |
| Procedure | Group | Cell Group | Cell Groups | Cell Group |
| Active Uplink | Yes | No | No | No |
| and/or | | | | |
| Downlink | | | | |
| Transmissions | | | | |
| L3 | Yes | Yes | Yes | Yes |
| Measurements | | | | |
| and/or | | | | |
| Reporting | | | | |
| L1 | Yes | No | No | Yes |
| Measurements | | | | |
| and/or | | | | |
| Reporting | | | | |
| Radio Link | Yes | Yes or No | No | No |
| Monitoring | | (Configurable) | | |
| Beam Failure | Yes | Yes or No | No | No |
| Detection | | (Configurable) | | |

In the example illustrated by Table 1, a UE 120 may be configured to perform a lower layer triggered mobility procedure using the master cell group. Here, the UE 120 may be configured to perform, using the master cell group, uplink and/or downlink transmissions (e.g., by PDCCH, PDSCH, PUCCH, PUSCH), layer 3 (L3) measurements and reporting (e.g., cell measurements and reporting, beam measurements and reporting), L1 measurements and reporting, radio link monitoring, and beam failure detection. In another example illustrated by Table 1, a UE 120 may be configured with a deactivated secondary cell group for 5G NR-DC. Here, the UE 120 may not be configured to perform, via the deactivated secondary cell group, active uplink and/or downlink transmissions or L1 measurements and reporting, and the UE 120 may be configured to perform, via the deactivated secondary cell group, L3 measurements and reporting. Further, the UE 120 may optionally be configured to perform, via the deactivated secondary cell group, radio link monitoring or beam failure detection.

In another example illustrated by Table 1, a UE 120 may be configured with a candidate secondary cell group for a 5G NR-DC conditional change. Here, the UE 120 may not be configured to perform, via the candidate secondary cell group, active uplink and/or downlink transmissions, L1 measurements and reporting, radio link monitoring, or beam failure detection, and the UE 120 may be configured to perform, via the candidate secondary cell group, L3 measurements and reporting. In another example illustrated by Table 1, a UE 120 may be configured with a candidate cell group for a lower layer triggered mobility procedure. Here, the UE 120 may not be configured to perform, via the candidate cell group, active uplink and/or downlink transmissions, radio link monitoring, or beam failure detection, and the UE 120 may be configured to perform, via the candidate secondary cell group, L3 measurements and reporting and L1 measurements and reporting.

In some other examples of the disaggregated network node architecture 200, a UE 120 may be configured with one or more active cell groups and one or more candidate cell groups (e.g., and may not be configured with any other type of cell group). Here, a functionality of deactivated secondary cell groups and candidate cell groups may be provided by the candidate cell groups. In particular, the candidate cell groups may be configured to enable the UE 120 to perform L1 measurements and reporting (e.g., for a mobility procedure, such as a DU controlled mobility procedure) via the candidate cell groups. Additionally, the candidate cell groups may be configured to enable the UE 120 to perform radio link monitoring and/or beam failure detection using the candidate cell groups. In some cases, a network node may configure radio link monitoring and beam failure detection on candidate cell groups based on a power saving parameter associated with the UE 120.

In the examples of the disaggregated network node architecture 200, a UE 120 may be configured with one or more active cell groups and one or more candidate cell groups (e.g., and may not be configured with any other type of cell group), the quantity of dual connectivity mobility procedures defined for a UE 120 that supports dual connectivity with a network node 110 may be reduced (e.g., as compared to when the UE 120 supports dual connectivity via a master node and a secondary node). For example, the dual connectivity mobility procedures may include a set of network-triggered dual connectivity mobility procedures. The set of network-triggered dual connectivity mobility procedures may include a candidate cell group activation procedure, an active cell group deactivation procedure, an active cell group modification procedure, a CU change procedure with or without a cell group change, a dual connectivity resume procedure with or without a cell group change. The dual connectivity mobility procedures may additionally include a set of UE triggered mobility procedures. The set of UE triggered mobility procedures may include a conditional candidate cell group activation procedure, a conditional cell group change procedure with one or both active cell groups being changed, a conditional handover procedure with a dual connectivity resumption, and a subsequent conditional candidate cell group activation or change procedure.

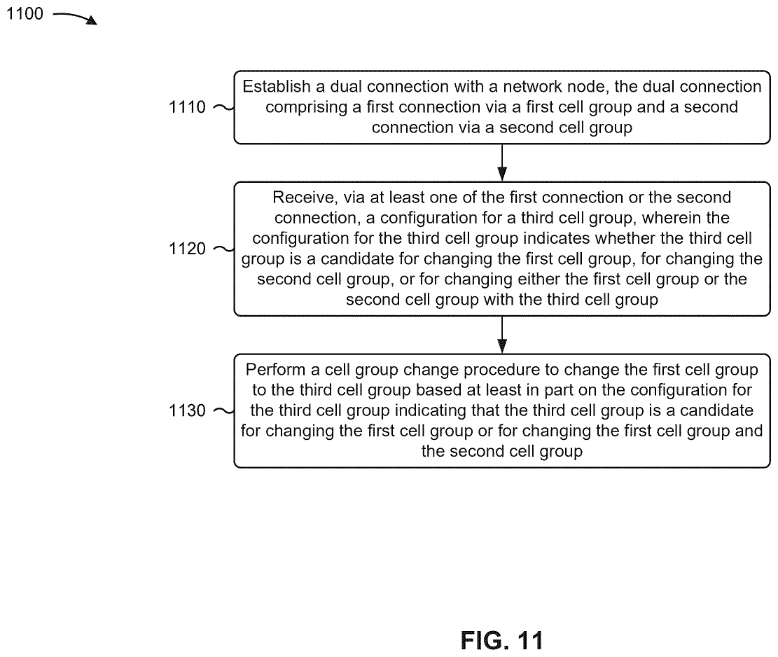

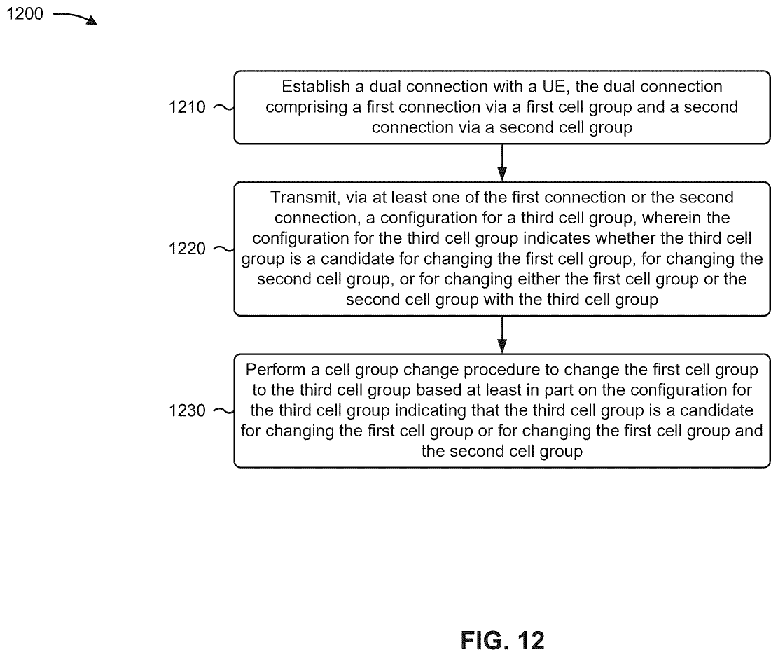

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with configuring candidate cell groups, as described in more detail elsewhere herein. For example, the processing system 145 of the network node 110, the processing system 140 of the UE 120, the CU 210, the DU 230, or the RU 240 may perform or direct operations of, for example, process 1100 of FIG. 11, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

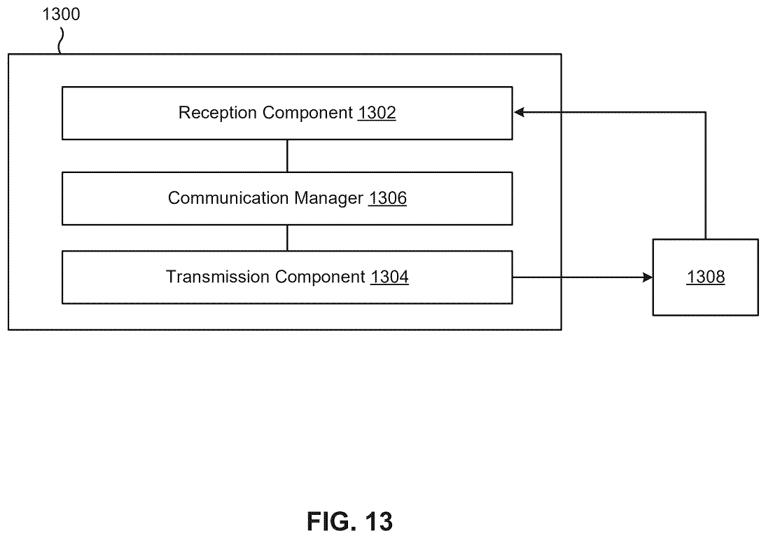

In some aspects, the UE 120 includes means for establishing a dual connection with a network node 110, the dual connection comprising a first connection via a first cell group and a second connection via a second cell group; means for receiving, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group; and/or means for performing a cell group change procedure to change the first cell group to the third cell group based at least in part on the configuration for the third cell group indicating that the third cell group is a candidate for changing the first cell group or for changing the first cell group and the second cell group. The means for the UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

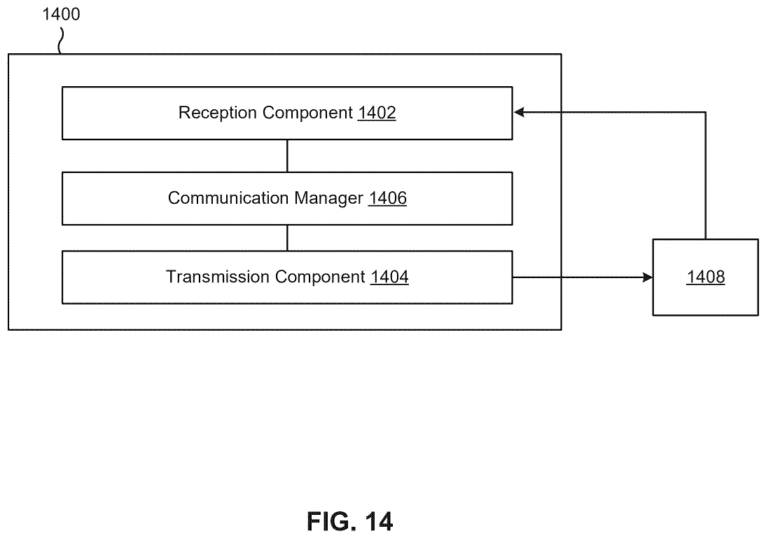

In some aspects, the network node 110 includes means for establishing a dual connection with a UE 120, the dual connection comprising a first connection via a first cell group and a second connection via a second cell group; means for transmitting, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group; and/or means for performing a cell group change procedure to change the first cell group to the third cell group based at least in part on the configuration for the third cell group indicating that the third cell group is a candidate for changing the first cell group or for changing the first cell group and the second cell group. The means for the network node 110 to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), and/or a transmission component (for example, transmission component 1404 depicted and described in connection with FIG. 14), among other examples.

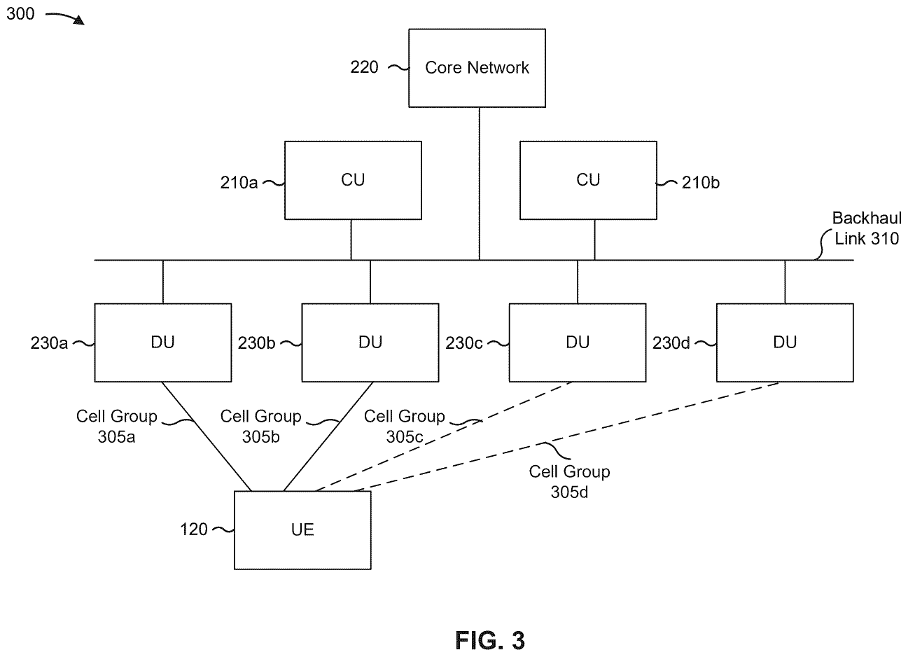

FIG. 3 is a diagram illustrating an example wireless communication network 300 illustrating a UE 120 that is communicating using dual connectivity, in accordance with the present disclosure. FIG. 3 illustrates the UE 120 communicating via a first cell group 305a associated with a first DU 230a and a second cell group 305b associated with a second DU 230b. The wireless communication network 300 may additionally include a third DU 230c associated with a third cell group 305c, a fourth DU 230d associated with a fourth cell group 305d, a first CU 210a, a second CU 210b, and a core network 220. In the example wireless communication network 300, the core network 220 may correspond to a 6G core network.

In the example communication network 300, the UE 120 may be controlled by a single CU 210 while being connected to one or more DUs 230. For example, the UE 120 may be controlled by the CU 210a while being connected to the DU 230a and the DU 230b. In some cases, the multiple connections between the UE 120 and the single CU 210a (e.g., via the DU 230a and the DU 230b) may not include a master or secondary connection. Instead, the single CU 210a may control and coordinate the multiple connections (e.g., via the backhaul link 310). In some cases, the backhaul link 310 may correspond to an API or to a point-to-point interface. As a result, the UE 120 may maintain a single security association for the multiple connections (e.g., as opposed to separate security associations for each connection). Additionally, multiple CUs 210 may not coordinate the multiple connections for the UE 120. Further, a single RRC state at the UE 120 and the CU 210a may be associated with the multiple connections. In some cases, the single CU 210a controlling the UE 120 may prevent a requirement for inter-CU 210 data forwarding.

Because the connections between the UE 120 and the CU 210a do not include a master cell group and a secondary cell group, a complexity of mobility procedures and dual connectivity may be decreased (e.g., as compared to connections that do include master cell groups and secondary cell groups). For example, the UE 120 may perform similar procedures to add, change, or release either cell group 305a or cell group 305b. That is, the UE 120 may not need to perform separate procedures for a master cell group and a secondary cell group. Further, the UE 120 may perform a same process if either cell group 305a or cell group 305b fails (e.g., a single failure) as opposed to separate procedures based on whether a master cell group or a secondary cell group fails. Further, while the example wireless communication network 300 illustrates the UE 120 being connected to two DUs 230 via two cell groups 305, the UE 120 may be connected to more DUs 230 (e.g., three DUs 230 via three cell groups 305, four DUs 230 via four cell groups 305) or fewer DUs 230 (e.g., one DU 230 via one cell group 305).

A network node (e.g., such as the CU 210a via the DU 230a or the DU 230b) may configure the UE 120 with one or more cell groups 305 (e.g., a cell group set). In some cases, the UE 120, in a connected mode, may support more than one type of cell group in the cell group set of that UE 120. The configured cell groups 305 may correspond to an active cell group or a candidate cell group. In the example wireless communication network 300, the network node (e.g., the CU 210a) may configure the cell group set for the UE 120 to include the cell group 305a, the cell group 305b, the cell group 305c, and the cell group 305d. Additionally, the network node may configure the cell group 305a and the cell group 305b as active cell groups for the UE 120 and may configure the cell group 305c and the cell group 305d as candidate cell groups for the UE 120.

An active cell group 305 (e.g., the cell group 305a and the cell group 305b) may be a cell group via which the UE 120 is connected to the core network 220 and is configured with signaling radio bearer (SRB) and data radio bearer (DRB) resources. A UE 120 may support normal radio resource management, radio link monitoring, and communication (e.g., transmission or reception) procedures via an active cell group 305. A candidate cell group 305 (e.g., the cell group 305c and the cell group 305d) may be a cell group that is prepared (e.g., via the network node) for different functions such as dual connectivity or mobility procedures, and are kept in a deactivated state with no radio resources until an activation of the candidate cell groups 305. A UE 120 may support limited radio resource management, radio link monitoring, or beam failure detection procedures for candidate cell groups 305 (e.g., based on a power saving metric associated with the UE 120, in accordance with a configuration for the candidate cell group 305). In some cases, the network node may configure the UE 120 to perform L3 and L1 measurements and reporting for both active cell groups 305 and candidate cell groups 305.

The example shown in FIG. 3 illustrates the UE 120 communicating with a network node (e.g., the CU 210a) via a dual connectivity connection. In particular, the UE 120 may have established a first RRC connection with the network node via a first cell group 305a and established a second RRC connection with the network node via a second cell group 305b. The UE 120 may communicate via the first and second cell groups 305 using one or more radio bearers (e.g., DRBs and/or SRBs). For example, the UE 120 may transmit or receive data via the first cell group 305a and the second cell group 305b using one or more DRBs. Similarly, the UE 120 may transmit or receive control information (e.g., RRC information and/or measurement reports) using one or more SRBs. In some aspects, a radio bearer may be dedicated to a specific cell group (e.g., a radio bearer may be dedicated to the first cell group 305a or the second cell group 305b). In some aspects, a radio bearer may be a split radio bearer. A split radio bearer may be split in the uplink and/or in the downlink. For example, a DRB may be split on the downlink (e.g., the UE 120 may receive downlink information for the first cell group 305a or the second cell group 305b via the DRB) but not on the uplink (e.g., the uplink may be non-split with a primary path to the first cell group 305a or the second cell group 305b, such that the UE 120 transmits in the uplink only on the primary path). In some aspects, a DRB may be split on the uplink with a primary path to the first cell group 305a or the second cell group 305b. A DRB that is split in the uplink may transmit data using the primary path until a size of an uplink transmit buffer satisfies an uplink data split threshold. If the uplink transmit buffer satisfies the uplink data split threshold, the UE 120 may transmit data to the first cell group 305a or the second cell group 305b using the DRB.

In the example wireless communication network 300, a UE 120 may configure dedicated candidate cell group sets and, optionally, a shared candidate cell group set. A dedicated candidate cell group set may include one or more cell groups 305 that are each configured with a same set of bearer resources (e.g., bearer L2/L1 resources). Here, each active cell group 305 may be associated with a dedicated candidate cell group set, and the UE 120 may be configured to perform handover procedures between any cell group 305 in a dedicated candidate cell group set. Additionally, to support dual connectivity, the UE 120 may establish a first connection with DU 230 using one cell group 305 from a first dedicated candidate cell group set and another cell group 305 from a second dedicated candidate cell group set. In the example 300, the cell group 305a may correspond to a first dedicated candidate cell group set and the cell group 305b may correspond to a second dedicated candidate cell group set. That is, the UE 120 may not be configured to establish two or more connections that are associated with cell groups 305 that are in a same dedicated candidate cell group set.

Additionally, a shared candidate cell group set may include one or more cell groups 305 that are configured to be shared between more than one active cell group 305. For example, a UE 120 may perform a handover from either a first active cell group 305a or a second active cell group 305b to a third cell group 305 within a shared candidate cell group set. A CU 210 may configure resources associated with each of the bearers configured for the UE 120 for cell groups 305 within a shared candidate cell group set. Then, the CU 210 may dynamically activate or deactivate the set of resources configured for a shared candidate cell group 305 when the candidate cell group 305 is activated (e.g., based on whether the candidate cell group 305 is activated for dual connectivity or a mobility procedure, based on one or more other cell groups 305 that are activated).

The wireless communication network 300 may support mobility between active cell groups 305 and candidate cell groups 305. For example, if the UE 120 moves, the CU 210a may activate the candidate cell groups 305c and 305d and deactivate the cell groups 305a and 305b. In some cases, the CU 210a may perform setup and release procedures with the DUs 230 to support the mobility of the UE 120 (e.g., without a master node or secondary node change or a master node handover).

As indicated above, FIG. 3 is provided as an example. Other examples may differ from what is described with respect to FIG. 3.

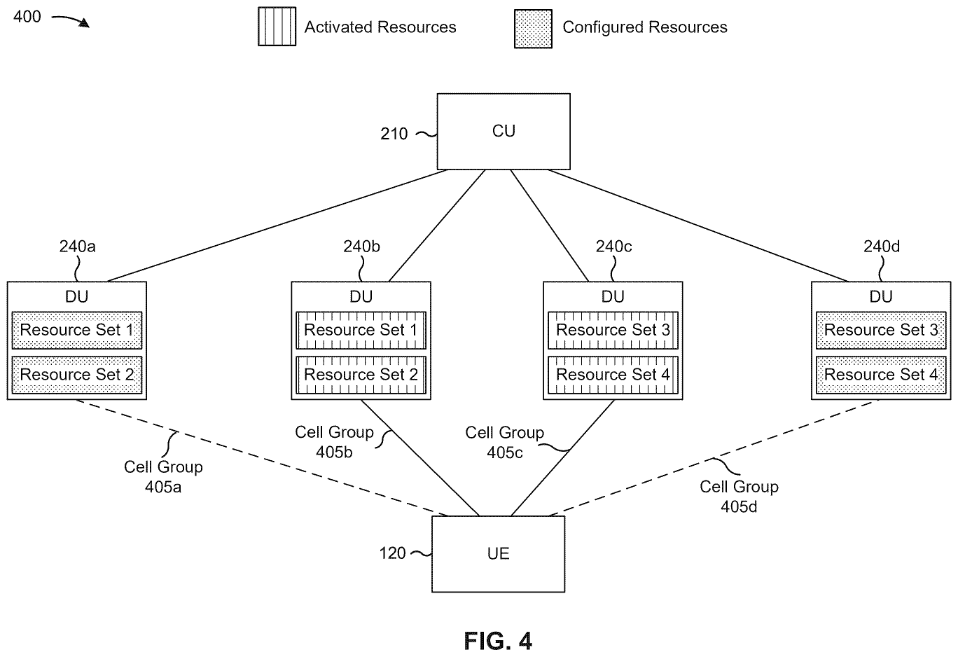

FIG. 4 is a diagram illustrating an example wireless communication network 400 illustrating a UE 120 that is communicating using dual connectivity, in accordance with the present disclosure. FIG. 4 illustrates the UE 120 communicating via a first cell group 405a associated with a first DU 230a and a second cell group 405b associated with a second DU 230b. The wireless communication network 400 may additionally include a third DU 230c associated with a third cell group 405c, a fourth DU 230d associated with a fourth cell group 405d, and a CU 210. The example wireless communication network 400 illustrates a UE 120 that is configured with a first dedicated candidate cell group set that includes the cell group 405a and the cell group 405b and a second dedicated candidate cell group set that includes the cell group 405c and the cell group 405d.

In the example wireless communication network 400, the UE 120 may establish a dual connection with the CU 210, and the dual connection may include a first connection (e.g., a first RRC connection) with the CU 210 via the cell group 405b and a second connection (e.g., a second RRC connection) with the CU 210 via the cell group 405c. The CU 210 may configure a dedicated candidate cell group set for each of the active cell groups 405, and each dedicated candidate cell group set may include one or more non-overlapping cell groups 405 (e.g., the CU 210 may not configure any dedicated candidate cell group set to include the same cell group 405). In the example wireless communication network 400, the cell group 405b and the cell group 405c may be active cell groups 405. Accordingly, the CU 210 may configure a first dedicated candidate cell group set for the active cell group 405b that includes the cell group 405a (and may additionally include one or more other candidate cell groups that are not illustrated in FIG. 4). Additionally, the CU 210 may configure a second dedicated candidate cell group set for the active cell group 405c that includes the cell group 405d (and may additionally include one or more other candidate cell groups that are not illustrated in FIG. 4). That is, the cell groups 405a and 405b may be associated with one dedicated candidate cell group set and the cell groups 405c and 405d may be associated with another dedicated candidate cell group set.

The CU 210 may configure four bearers for communicating with the UE 120. For example, the CU 210 may configure a first DRB, a second DRB, a third radio bearer, and a fourth DRB for communications with the UE 120. Each of the bearers may in turn be associated with a resource set. For example, the resource set 1 may correspond to resources for communications via the first DRB, the resource set 2 may correspond to resources for communications via the second DRB, the resource set 3 may correspond to resources for communications via the third DRB, and the resource set 4 may correspond to resources for communications via the fourth DRB.

The CU 210 may configure resources associated with the bearers (e.g., the four DRBs configured for communications between the CU 210 and the UE 120) for each of the cell groups 405. For dedicated candidate cell group sets, the CU 210 may configure each cell group 405 within a same dedicated candidate cell group set with a same set of resources. Additionally, each different dedicated candidate cell group set may be configured with non-overlapping resources. For example, the CU 210 may configure the cell groups 405 in a first dedicated resource set (e.g., the cell group 405a and the cell group 405b) with the resource set 1 and the resource set 2. Additionally, the CU 210 may configure the cell groups 405 in a second dedicated resource set (e.g., the cell group 405c and the cell group 405d) with the resource set 3 and the resource set 4.

If the UE 120 performs a handover from an active cell group 405 to one of the candidate cell groups 405 within the dedicated cell group set that is associated with the active cell group, the UE 120 may activate each of the resources for the candidate cell group 405. For example, if the UE 120 performs a handover from the active cell group 405b to the active cell group 405a, the UE 120 may activate the resource set 1 and the resource set 2 (e.g., the L1/L2 resources within the resource set 1 and the resource set 2 that are associated with the first and second DRBs) during an execution of the handover. In another example, if the UE 120 performs a handover from the active cell group 405c to the active cell group 405d, the UE 120 may activate the resource set 3 and the resource set 4 (e.g., the L1/L2 resources within the resource set 3 and the resource set 4 that are associated with the third and fourth DRBs) during an execution of the handover.

As indicated above, FIG. 4 is provided as an example. Other examples may differ from what is described with respect to FIG. 4.

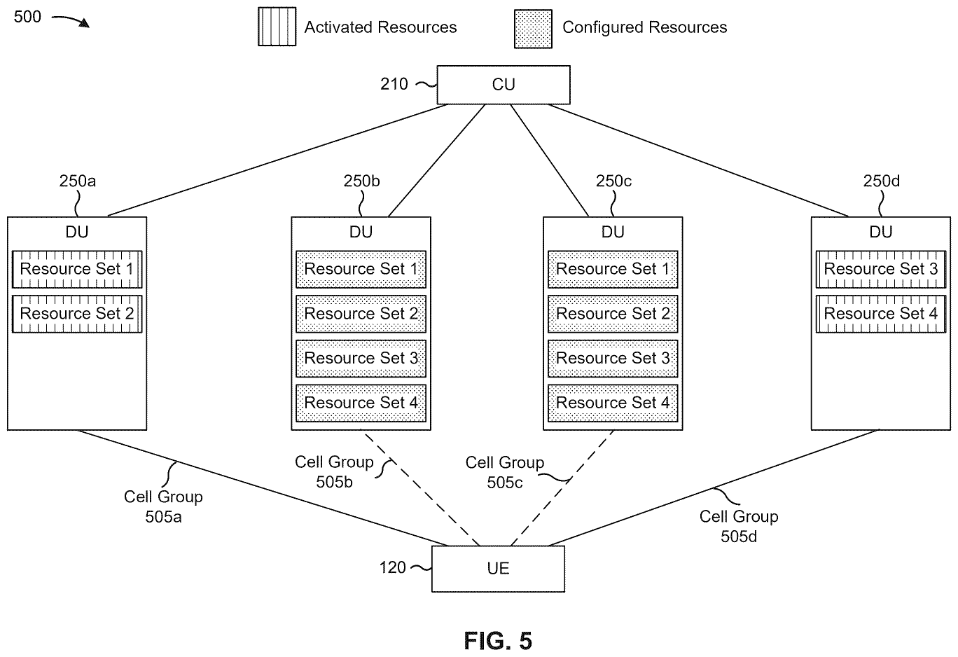

FIG. 5 is a diagram illustrating an example wireless communication network 500 illustrating a UE 120 that is communicating using dual connectivity, in accordance with the present disclosure. FIG. 5 illustrates the UE 120 communicating via a first cell group 505a associated with a first DU 230a and a second cell group 505b associated with a second DU 230b. The wireless communication network 500 may additionally include a third DU 230c associated with a third cell group 505c, a fourth DU 230d associated with a fourth cell group 505d, and a CU 210. The example wireless communication network 500 illustrates a UE 120 that is configured with a shared candidate cell group set that includes the cell group 505b and the cell group 505c.

The CU 210 may configure four bearers for communicating with the UE 120. For example, the CU 210 may configure a first DRB, a second DRB, a third radio bearer, and a fourth DRB for communications with the UE 120. Each of the bearers may in turn be associated with a resource set. For example, the resource set 1 may correspond to resources for communications via the first DRB, the resource set 2 may correspond to resources for communications via the second DRB, the resource set 3 may correspond to resources for communications via the third DRB, and the resource set 4 may correspond to resources for communications via the fourth DRB.

In the example wireless communication network 500, the UE 120 may establish a dual connection with the CU 210, and the dual connection may include a first connection (e.g., a first RRC connection) with the CU 210 via the cell group 505a and a second connection (e.g., a second RRC connection) with the CU 210 via the cell group 505d. In the example wireless communication network 500, the CU 210 may configure the cell group 505a to with the resource set 1 and the resource set 2 and may configure the cell group 505d with the resource set 3 and the resource set 4. Accordingly, when the UE 120 has activated dual connectivity with the CU 210 via the cell group 505a and the cell group 505d, the UE 120 may communicate with the CU 210 using the resource set 1 and the resource set 2 (e.g., associated with the first and second DRBs) via the cell group 505a and using the resource set 3 and the resource set 4 (e.g., associated with the third and fourth DRBs) via the cell group 505d.

The CU 210 may configure a shared candidate cell group set for each of the active cell groups 505, and the shared candidate cell group set may include one or more candidate cell groups 505 that are shared among the active cell groups 405. In the example wireless communication network 500, the cell group 505a and the cell group 505d may be active cell groups 505. Accordingly, the CU 210 may configure a shared candidate cell group set that includes the cell group 505b and the cell group 505c (and may additionally include one or more other candidate cell groups that are not illustrated in FIG. 5).

The CU 210 may configure (e.g., during a candidate cell group preparation) the cell groups 505 within the shared candidate cell group set with the resources associated with each of the bearers. That is, candidate cell groups (e.g., that are candidate cell groups 505 for dual connectivity and/or handover procedures) within a shared candidate cell group set may be configured with the resources for all of the bearers configured for communications between the UE 120 and the CU 210. In the example wireless communication network 500, the CU 210 may configure the cell groups 505 within the shared candidate cell group set (e.g., the cell group 505b and the cell group 505c) with the resource set 1 (e.g., associated with the first DRB), the resource set 2 (e.g., associated with the second DRB), the resource set 3 (e.g., associated with the third DRB), and the resource set 4 (e.g., associated with the fourth DRB).

If a candidate cell group 505 from a shared candidate cell group set is activated (e.g., for dual connectivity, for a handover procedure), one or more of the resource sets configured for that candidate cell group 505 may be dynamically activated. For example, if the UE 120 performs a first handover from the active cell group 505a to the candidate cell group 505b and a second handover from the active cell group 505d to the candidate cell group 505c, the CU 210 may transmit signaling activating a subset of the configured resource sets for the activated cell group 505b and the activated cell group 505c. For example, the CU 210 may indicate for the UE 120 to activate the resource set 1, the resource set 3, and the resource set 4 for the cell group 505b. Additionally, the CU 210 may indicate for the UE 120 to activate the resource set 2 for the cell group 505c. Accordingly, the UE 120 may activate a portion of the configured resource sets for cell groups 505 within a shared candidate cell group set based on a dynamic indication of the resource sets to be activated during an execution of a handover procedure to the cell group 505 or an activation of dual connectivity that includes activating the cell group 505.

If the UE 120 performs a handover from an active cell group 505 to one of the candidate cell groups 505 within the dedicated cell group set that is associated with the active cell group, the UE 120 may activate each of the resources for the candidate cell group 505. For example, if the UE 120 performs a handover from the active cell group 505b to the active cell group 505a, the UE 120 may activate the resource set 1 and the resource set 2 (e.g., the L1/L2 resources within the resource set 1 and the resource set 2 that are associated with the first and second DRBs) during an execution of the handover. In another example, if the UE 120 performs a handover from the active cell group 505c to the active cell group 505d, the UE 120 may activate the resource set 3 and the resource set 5 (e.g., the L1/L2 resources within the resource set 3 and the resource set 5 that are associated with the third and fourth DRBs) during an execution of the handover.

As indicated above, FIG. 5 is provided as an example. Other examples may differ from what is described with respect to FIG. 5.

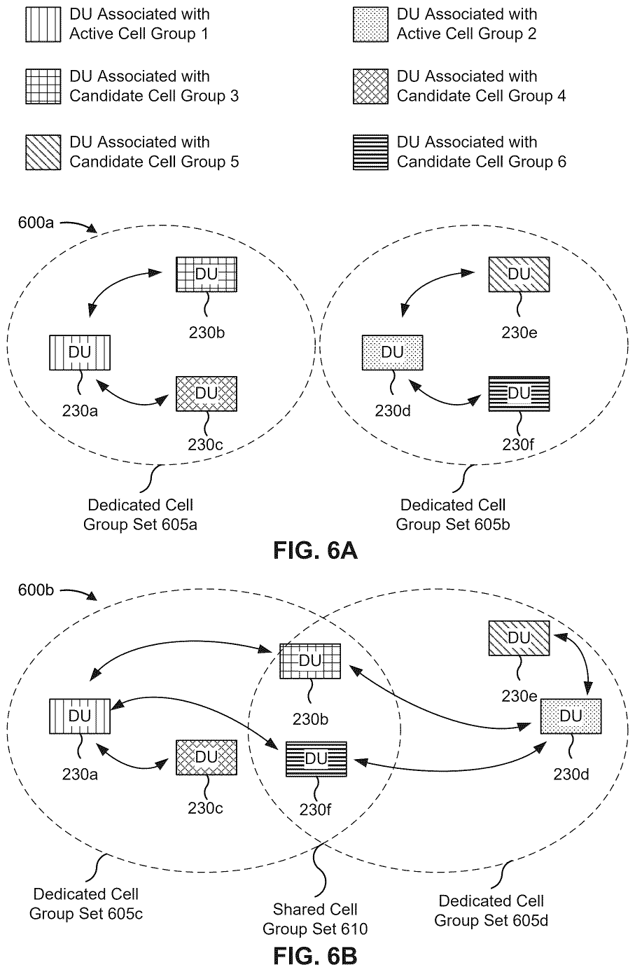

FIGS. 6A and 6B are diagrams illustrating examples 600 of cell group set configurations, in accordance with the present disclosure. FIGS. 6A and 6B illustrate examples of two cell groups being activated to support a dual connectivity of a UE 120 with a CU 210, as described herein. In particular, the examples 600a and 600b illustrate a first DU 230a that is associated with a first active cell group 1 and a second DU 230d that is associated with a second active cell group 2. The examples 600 may additionally indicate a DU 230b that is associated with a candidate cell group 3, a DU 230c that is associated with a candidate cell group 4, a DU 230e that is associated with a candidate cell group 5, and a DU 230f that is associated with a candidate cell group 6.

The example 600a illustrates a configuration of two dedicated cell group sets: the dedicated cell group set 605a and the dedicated cell group set 605b. A CU 210 may configure a dedicated cell group set 605 for each active cell group. In the example 600a, the CU 210 may configure the dedicated cell group set 605a for the active cell group 1 and may configure the dedicated cell group set 605b for the active cell group 2. The dedicated cell group set 605a and the dedicated cell group set 605b may not include any overlapping cell groups. That is, the dedicated cell group set 605a may include the cell group 1, the cell group 3, and the cell group 4, and the dedicated cell group set 605b may include the cell group 2, the cell group 5, and the cell group 6.

To configure the cell groups within the dedicated cell group set 605a and the dedicated cell group set 605b, the CU may configure the cell groups with the resources (e.g., the L2/L1 resources) for the bearers that use the cell group resources. For example, the CU may configure each of the cell group 1, the cell group 3, and the cell group 4 (e.g., the cell groups within the dedicated cell group 605a) with the same resource sets. Additionally, the CU may configure each of the cell group 2, the cell group 5, and the cell group 6 with the same resource sets. The CU 210 may determine a split of the bearers between cell groups in dual connectivity (e.g., between cell groups each associated with different dedicate cell group sets 605).

When the CU 210 configures the cell groups within the dedicated cell group sets 605, the CU 210 may indicate, for each configured cell group, one or more other cell groups for which the configured cell group is a candidate for a change procedure (e.g., for which other cell groups the configured cell group is capable of being a target cell group for a mobility procedure). That is, for a cell group within the dedicated cell group set 605a, the CU 210 may indicate, in the configuration for the cell group, that the cell group is a candidate for a change procedure for any of the other configured cell groups within the dedicated cell group set 605a. Additionally, for a cell group within the dedicated cell group set 605b, the CU 210 may indicate, in the configuration for the cell group, that the cell group is a candidate for a change procedure for any of the other configured cell groups within the dedicated cell group set 605b. The CU 210 may include a list of cell group identifiers within a configuration for a candidate cell group, and the list of cell group identifiers may correspond to the one or more cell groups for which the configured candidate cell group supports a mobility procedure (e.g., as a target candidate cell, for which cell groups the configured candidate cell group supports change procedures).

The CU may indicate the configuration for cell groups within the dedicated cell group set 605a and/or the dedicated cell group set 605b using a delta configuration. For example, a dedicated cell group set 605 may be associated with a predefined cell group configuration. To configure a cell group using the delta configuration, the CU 210 may indicate the cell group configuration by indicating a difference between the cell group and the predefined cell group associated with the dedicated cell group set 605. For example, the CU 210 may indicate, within the delta configuration, one or more parameters associated with the cell group that are different from one or more of the parameters associated with the predefined cell group. In some cases, the CU 210 may use the delta configuration for cell group activation or cell group deactivation.

A UE 120 may be configured to report measurements of any candidate cell group within a dedicated cell group set 605 via the active cell group in the dedicated cell group set 605. For example, the UE 120 may report measurements of the candidate cell group 3 and the candidate cell group 4 via the active cell group 1. Additionally, the UE 120 may report measurements of the candidate cell group 5 and the candidate cell group 6 via the active cell group 2.

For some procedures (e.g., for lower layer triggered mobility procedures), the UE 120 may be configured to handover to a target cell group that is within the same dedicated cell group set 605 as the source cell group. For example, the UE 120 may perform a lower layer triggered mobility procedure switch from communicating via the active cell group 1 (e.g., the active cell group within the dedicated cell group set 605a) to either the candidate cell group 3 or the candidate cell group 4 (e.g., the candidate cell groups within the same dedicated cell group set 605a). Additionally, the UE 120 may perform a lower layer triggered mobility procedure switch from communicating via the active cell group 2 (e.g., the active cell group within the dedicated cell group set 605b) to either the candidate cell group 5 or the candidate cell group 6 (e.g., the candidate cell groups within the same dedicated cell group set 605b).

The example 600b illustrates a configuration of two dedicated cell group sets: the dedicated cell group set 605c and the dedicated cell group set 605d, in addition to the configuration of a shared cell group set 610. A CU 210 may configure a dedicated cell group set 605 for each active cell group. In the example 600b, the CU 210 may configure the dedicated cell group set 605c for the active cell group 1 and may configure the dedicated cell group set 605d for the active cell group 2. The dedicated cell group set 605c may include the cell group 1, the cell group 3, the cell group 4, and the cell group 6, and the dedicated cell group set 605d may include the cell group 2, the cell group 3, the cell group 5, and the cell group 6. Both the dedicated cell group set 605c and the dedicated cell group set 605d may include the cell group 3 and the cell group 6. The cell groups that are in both dedicated cell group sets 605 may correspond to a shared cell group set 610. In particular, the shared cell group set 610 may include the cell group 3 and the cell group 6.

A CU 210 may configure (e.g., during a candidate cell group preparation) the cell groups within the shared candidate cell group set 610 with the resources associated with each of the bearers. That is, the candidate cell group 3 and the candidate cell group 6 within the shared candidate cell group set 610 may be configured with the resources for all of the bearers configured for communications between the UE 120 and the CU 210. During an execution phase (e.g., during a candidate cell group activation procedure) of a candidate cell group within the shared candidate cell group set 610, the CU 210 may decide (e.g., based on information from a DU 230 of active cell groups, by itself) to activate resources (e.g., L2/L1 resources) for a subset of bearers that are configured during a candidate cell group preparation of the candidate cell group.

When the CU 210 configures the cell groups within the shared candidate cell group set 610, the CU 210 may indicate, for each configured cell group, one or more other cell groups for which the configured cell group is a candidate for a change procedure. That is, for a cell group within the shared candidate cell group set 610, the CU 210 may indicate, in the configuration for the cell group, that the cell group is a candidate for a change procedure for any of the other configured cell groups. For example, the configuration for the candidate cell group 3 may indicate that the candidate cell group 3 is capable of being a target cell group for mobility procedures from any of the other cell groups (e.g., from the cell groups 1, 2, 4, 5, and 6). Additionally, the configuration for the candidate cell group 6 may indicate that the candidate cell group 6 is capable of being the target cell group for mobility procedures from any of the other cell groups (e.g., from the cell groups 1, 2, 3, 4, and 5). In some cases, the CU 210 may include a list of cell group identifiers within a configuration for a candidate cell group, and the list of cell group identifiers may correspond to the one or more cell groups for which the configured candidate cell group supports a mobility procedure (e.g., as a target candidate cell, for which cell groups the configured candidate cell group supports change procedures).

The CU 210 may indicate the configuration for cell groups within the shared group set 610 using a delta configuration. For example, the shared group set 610 may be associated with a predefined cell group configuration. To configure a cell group using the delta configuration, the CU 210 may indicate the cell group configuration by indicating a difference between the cell group and the predefined cell group associated with the shared cell group set 610. For example, the CU 210 may indicate, within the delta configuration, one or more parameters associated with the cell group that are different from one or more of the parameters associated with the predefined cell group. In some cases, the CU 210 may use the delta configuration for activation or deactivation procedures of cell groups within the shared cell group set 610.

A UE 120 may be configured to report measurements of the candidate cell groups within the shared cell group set 610 via any active cell group. For example, the UE 120 may report measurements of the candidate cell group 3 via either the active cell group 1 or the active cell group 2. Additionally, the UE 120 may report measurements of the candidate cell group 6 via either the active cell group 1 or the active cell group 2.

To change an active cell group for a UE 120 that is communicating with a CU via dual connectivity (e.g., via the active cell group 1 and the active cell group 2), the UE 120 may change the active cell group to a target cell group that is within the dedicated cell group set 605 associated with the active cell group and any cell group that is within the shared cell group 610. That is, a UE 120 may change either active cell group to one of the shared cell groups.

As indicated above, FIGS. 6A and 6B are provided as examples. Other examples may differ from what is described with respect to FIGS. 6A and 6B.

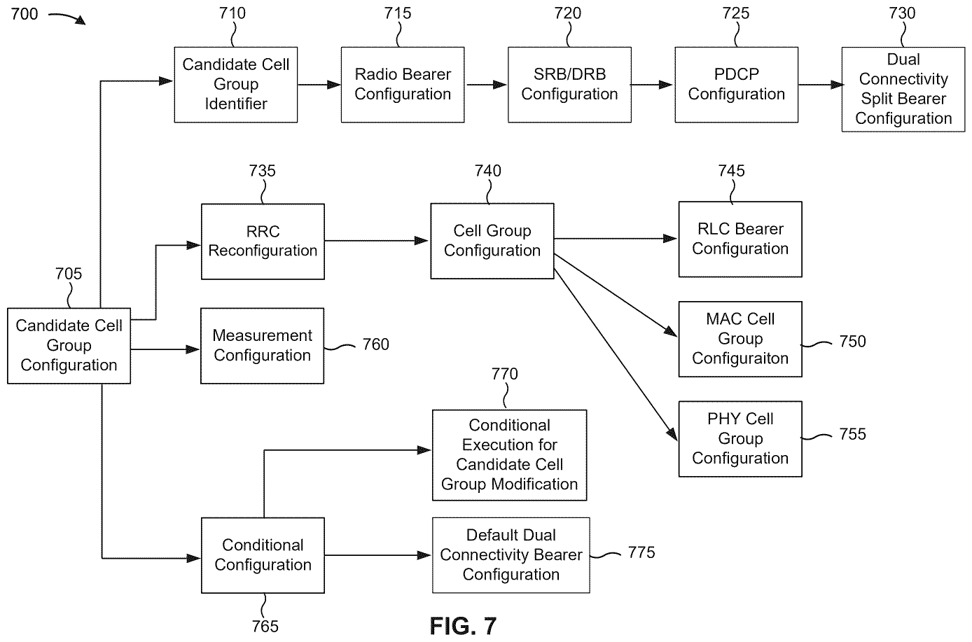

FIG. 7 is a diagram illustrating an example 700 of a candidate cell group configuration 705, in accordance with the present disclosure. In some cases, a network node (e.g., including a CU 210, including a DU 230) may use the candidate cell group configuration 705 to configure one or more candidate cell groups for a dedicated cell group set or for a shared cell group set, as described herein. In the example 700, the candidate cell group configuration 705 may be for a candidate cell group within a shared candidate cell group set.

The candidate cell group configuration 705 may indicate a candidate cell group identifier 710 associated with the candidate cell group. The candidate cell group identifier 710 may in turn indicate a radio bearer configuration 715 associated with the candidate cell group. In an example where the cell group configuration 705 is for a candidate cell group that is within a shared cell group set, the radio bearer configuration 715 may configure a complete set of UE bearers for the candidate cell group (e.g., similar to a configuration for a cell group configured for a conditional handover). In some cases, configuring the complete set of UE bearers for the candidate cell group may enable the candidate cell group to be a candidate cell group for either dual connectivity or a handover procedure. The radio bearer configuration 715 may indicate an SRB and DRB configuration 720 for the candidate cell group. As described herein, the SRB and DRB configuration 720 may configure the complete set of UE bearers (e.g., all of the UE SRBs and all of the UE DRBs) for the candidate cell group.

The SRB and DRB configuration 720 for the candidate cell group may include the signaling and data radio bearer configuration for different layers of the UE radio protocol stack. For example, the SRB and DRB configuration 720 may indicate a PDCP configuration 725 associated with the candidate cell group, which may in turn indicate a dual connectivity split bearer configuration 730 for the candidate cell group.

The candidate cell group configuration 705 may additionally indicate an RRC reconfiguration 735 associated with the candidate cell group. The RRC reconfiguration 735 may indicate a cell group configuration 740 associated with the candidate cell group. The cell group configuration 740 may indicate an RLC bearer configuration 745 for the candidate cell group, a MAC cell group configuration 750 for the candidate cell group, and a PHY cell group configuration 755 for the candidate cell group.

The candidate cell group configuration 705 may also indicate a measurement configuration 760 for the candidate cell group.

The candidate cell group configuration 705 may further indicate a conditional configuration 765 associated with the candidate cell group. The conditional configuration 765 may indicate conditional criteria on when the candidate cell group is suitable for a change procedure (e.g., from one active cell group to the candidate cell group) or for an activation of dual connectivity via the candidate cell group. For example, the criteria may include one or more conditional execution conditions for candidate cell group modification 770 and a default dual connectivity bearer configuration 775 associated with the candidate cell group. The one or more conditional execution conditions may correspond to one or more conditions to trigger the UE to perform a candidate cell group activation or deactivation, a candidate cell group change, a candidate cell group allocation procedure, a candidate cell group deallocation procedure, a candidate cell group configuration procedure, or a conditional handover.

The default dual connectivity bearer configuration 775 may indicate a default configuration for the candidate cell group that is applied (e.g., by default) upon an activation of the candidate cell group (such as when the candidate cell group is added to activate dual connectivity or when the candidate cell group is activated based on being a target cell group for a cell group change procedure). That is, if a UE does not receive explicit signaling from a network node indicating a bearer configuration for the candidate cell group during an activation phase for the candidate cell group, the UE may apply the default configuration indicated by the default dual connectivity bearer configuration 775. In some examples, the default dual connectivity bearer configuration 775 may indicate one or more split bearers associated with the candidate cell group (e.g., one or more split radio bearer identifiers indicating the one or more split bearers) and an active radio link control-bearer-per-cell group configuration for the candidate cell group (e.g., a radio link control-bearer logical channel identifier) for the candidate cell group.

When a handover event occurs, a UE may apply the entire configuration of the candidate cell group (e.g., as indicated by the candidate cell group configuration) on the newly activated cell group. In the example 700, the candidate cell group configuration 705 may include a radio bearer configuration 715 that configures the complete set of UE bearers for the candidate cell group. Accordingly, when the handover event occurs, the UE may activate the complete set of the UE bearers for the candidate cell group.

In some cases, a UE may activate dual connectivity by activating the candidate cell group configured by the candidate cell group 705. Additionally, the UE may switch an active cell group for the dual connectivity of the UE to the candidate cell group configured by the candidate cell group 705. In either case, when the UE activates the candidate cell group for dual connectivity, the UE may determine whether a split bearer is configured for the dual connectivity, and what a split threshold configuration for the dual connectivity is, based on the candidate cell group configuration 705. In one example, the candidate cell group configuration 705 may statically configure whether the split bearer is configured for the dual connectivity, and what a split threshold configuration for the dual connectivity is via the dual connectivity split bearer configuration 730 within the candidate cell group configuration 705. Additionally, or alternatively, the CU 210 may dynamically control whether each of the resource sets (e.g., the L2/L1 resources) is provided for a bearer during an activation phase of the candidate cell group.

As indicated above, FIG. 7 is provided as an example. Other examples may differ from what is described with respect to FIG. 7.

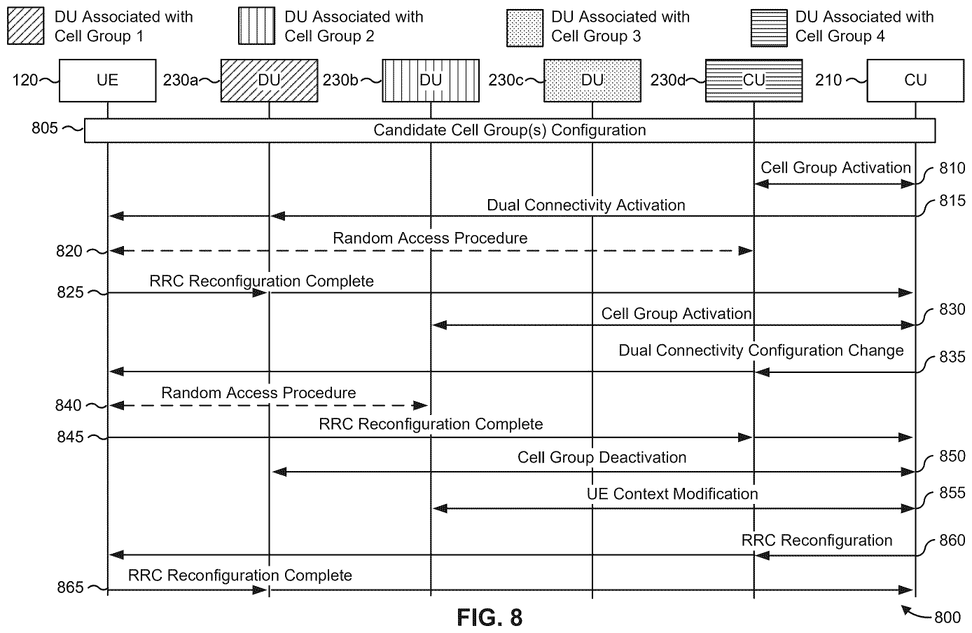

FIG. 8 is a diagram illustrating an example 800 associated with configuring candidate cell groups, in accordance with the present disclosure. As shown in FIG. 8, a UE 120, a DU 230a, a DU 230b, a DU 230c, a DU 230d, and a CU 210 may communicate with one another. The example 800 illustrates one or more operations associated with dual connectivity mobility among candidate cell groups associated with dedicated candidate cell group sets. The CU 210 may correspond to a CU control plane, a service, a connection service, a mobility function, or a mobility service.

In some cases, a first network node 110 may include the DU 230a, a second network node 110 may include the DU 230b, a third network node may include the DU 230c, a fourth network node 110 may include the DU 230d, and a fifth network node 110 may include the CU 210. Additionally, or alternatively, a single network node 110 may include more than one of the DUs 230 and/or the CU 210. In the example 800, the DU 230a may support a first cell group (e.g., the cell group 1), the DU 230b may support a second cell group (e.g., the cell group 2), the DU 230c may support a third cell group (e.g., the cell group 3), and the DU 230d may support a fourth cell group (e.g., the cell group 4). The communication between the DUs 230 and the CU 210 may be carried by an API (e.g., a service-based architecture API) or a point-to-point interface. In some cases, the CU-DU communication may be carried by an API when the RRC connection between the UE 120 and the CU 210 corresponds to an association between the UE 120 and the connectivity function based on an identifier shared during an establishment of the association. Additionally, the CU-DU communication may be carried by a point-to-point interface when the RRC connection between the UE 120 and the CU 210 is a point-to-point interface between the UE 120 and the connectivity function.

At 805, the CU 210 may configure one or more candidate cell groups. That is, the UE 120 may be in a connected state and may receive, from the CU 210, a configuration for the candidate cell groups. The cell candidate cell groups may be configured to support dual connectivity of the UE 120, a handover of the UE 120, and/or a conditional handover of the UE 120. In the example 800, the UE 120 may be connected to the CU 210 via the active cell group 1. In this example, the UE 120 may receive the configuration for the candidate cell groups 2, 3, and 4 via the DU 230a. The configuration for the candidate cell groups may configure the cell group 1 and the candidate cell group 2 within a first dedicated cell group set. Additionally, the configuration for the candidate cell groups may configure the candidate cell group 3 and the candidate cell group 4 within a second dedicated cell group set.

In some cases, the CU 210 may indicate, to each of the DUs 230 associated with the UE 120, the full UE context. Indicating the full UE context to each of the DUs 230 may enable any of the DUs 230 to perform a context transfer by sending the full UE context to a new CU 210 (e.g., not illustrated in FIG. 8), for example, when a DU 230 loses connectivity with the original CU 210 (e.g., illustrated in FIG. 8). The new CU 210 may then inform the remaining DUs 230 associated with the UE 120 of the CU identifier of the new CU 210.

After configuring the candidate cell groups, the CU 210 may activate a dual connectivity of the UE 120 with the CU 210. In particular, the CU 210 may activate the dual connectivity of the UE 120 via the cell group 1 from the first dedicated cell group set and the cell group 4 from the second dedicated cell group set. The operations associated with activating the dual connectivity of the UE 120 with the CU 210 are described with reference to 810, 815, 820, and 825.

At 810, the CU 210 may perform a cell group activation procedure with the DU 230d. In particular, the CU 210 may transmit, and the DU 230d may receive, a UE context setup or modification request message (e.g., via an API or via a point-to-point interface) indicated for the DU 230d to activate the cell group 4. Based on receiving the UE context setup or modification request message, the DU 230d may activate the cell group 4 and transmit, to the CU 210, a UE context setup or modification response message confirming the activation of the cell group 4.

At 815, the CU 210 may transmit, to the UE 120 via the DU 230a, a dual connectivity activation command. In particular, the CU 210 may transmit an RRC reconfiguration message (e.g., an RRC transfer request message) via an API or via a point-to-point interface that indicates for the UE 120 to activate a dual connectivity and indicates a dual connectivity configuration. The dual connectivity configuration may indicate two or more active cell groups for the dual connectivity of the UE 120 with the CU 210. In the example 800, the dual connectivity configuration may indicate for the UE to activate dual connectivity with the CU 210 via the active cell group 1 and the active cell group 4.

At 820, the UE 120 may optionally perform a random access procedure. That is, if the configuration associated with the cell group 4 does not configure an activation procedure of the cell group 4 without performing a random access procedure, the UE 120 may perform the random access procedure with the DU 230d to activate the cell group 4 at 820. Additionally, if the configuration associated with the cell group 4 does configure an activation procedure of the cell group 4 without performing the random access procedure, the UE 120 may refrain from performing the random access procedure with the DU 230d at 820.

At 825, the UE 120 may transmit (e.g., via the active cell group 1 associated with the DU 230a) an RRC reconfiguration complete message. That is, the UE 120 may transmit the RRC reconfiguration complete message to the DU 230a, and the DU 230a may transmit the RRC reconfiguration complete message to the CU 210 via an API or via a point-to-point interface. The RRC reconfiguration complete message may correspond to an RRC transfer response message and may indicate that the UE 120 has completed an activation of the cell group indicated for the UE 120 to activate by the CU 210 at 815. In the example 800, the RRC reconfiguration complete message may indicate that the UE 120 has activated the dual connectivity of the UE 120 via the active cell group 1 and the active cell group 4.

After the UE 120 activates the dual connectivity of the UE 120 via the cell group 1 and the cell group 4, the UE 120 may perform an active cell group change while maintaining the dual connectivity of the UE 120. In particular, the UE 120 may perform a cell group change procedure to change the active cell group 1 with the candidate cell group 2. While FIG. 8 illustrates an example where the CU 210 initiates the cell group change, in other examples a DU 230 may initiate the cell group change or the UE 120 may initiate the cell group change. The operations associated with this cell group change procedure are described with reference to 830, 835, 840, 845, and 850.

At 830, the CU 210 may transmit, and the DU 230b may receive, an indication to activate the candidate cell group 2. In particular, the CU 210 may transmit, and the DU 230b may receive, a UE context setup or modification request message (e.g., via an API or via a point-to-point interface) indicated for the DU 230b to activate the cell group 2. Based on receiving the UE context setup or modification request message, the DU 230b may activate the cell group 2 and transmit, to the CU 210, a UE context setup or modification response message confirming the activation of the cell group 2.

At 835, the CU 210 may transmit, to the UE 120 via the DU 230d, a dual connectivity configuration change indication. In one example, the CU 210 may transmit an RRC reconfiguration message (e.g., an RRC transfer request message) via an API or via a point-to-point interface that indicates the dual connectivity configuration change indication. In another example, the CU 210 may transmit lower layer signaling (e.g., for a lower layer triggered mobility procedure, L1 or L2 signaling) that indicates the dual connectivity configuration change indication. The dual connectivity configuration change indication indicates for the UE 120 to change the dual connectivity configuration and indicates the changed dual connectivity configuration. For example, the dual connectivity configuration change indication may indicate for the UE 120 to perform a change procedure from the active cell group 1 to the active cell group 2.

In some cases, the dual connectivity change indication may indicate for the UE 120 to perform a change procedure that is in accordance with the candidate cell group configurations. For example, the target cell group indicated by the dual connectivity configuration change may be configured as a cell group that supports cell group change procedures from the source cell group indicated by the dual connectivity change indication. In the example 800, the cell group 2 may be configured to support cell group change procedures from the cell group 1 based on the cell group 1 and the cell group 2 being configured within a same dedicated candidate cell group set.

The changed dual connectivity configuration may indicate two or more active cell groups for the dual connectivity of the UE 120 with the CU 210. In the example 800, the changed dual connectivity configuration may indicate for the UE to activate dual connectivity with the CU 210 via the active cell group 2 and the active cell group 4.

At 840, the UE 120 may optionally perform a random access procedure. That is, if the configuration associated with the cell group 2 does not configure an activation procedure of the cell group 2 without performing a random access procedure, the UE 120 may perform the random access procedure with the DU 230b to activate the cell group 2 at 840. Additionally, if the configuration associated with the cell group 2 does configure an activation procedure of the cell group 2 without performing the random access procedure, the UE 120 may refrain from performing the random access procedure with the DU 230b at 840.

Based on receiving the dual connectivity configuration change indication, the UE 120 may activate the candidate cell group 2 and deactivate the candidate cell group 1. Then, at 845, the UE 120 may transmit (e.g., via the active cell group 4 associated with the DU 230d) an RRC reconfiguration complete message. That is, the UE 120 may transmit the RRC reconfiguration complete message to the DU 230d, and the DU 230d may transmit the RRC reconfiguration complete message to the CU 210 via an API or via a point-to-point interface. The RRC reconfiguration complete message may correspond to an RRC transfer response message and may indicate that the UE 120 has completed the dual connectivity cell group change procedure. In the example 800, the RRC reconfiguration complete message may indicate that the UE 120 has activated the cell group 2 and deactivated the cell group 1.

At 850, the CU 210 may transmit, and the DU 230a may receive, an indication to deactivate the candidate cell group 1. In particular, the CU 210 may transmit, and the DU 230a may receive, a UE context setup or modification request message (e.g., via an API or via a point-to-point interface) indicated for the DU 230a to deactivate the cell group 1. Based on receiving the UE context setup or modification request message, the DU 230a may deactivate the cell group 1 and transmit, to the CU 210, a UE context setup or modification response message confirming the deactivation of the cell group 1.

After changing the dual connectivity configuration of the UE 120, the UE 120 and the network node may perform an active cell group modification procedure to modify a configuration of the candidate cell group 2. The operations associated with the active cell group modification procedure are described with reference to 855, 860, and 865.

At 855, the CU 210 and the DU 230b may perform a UE context modification procedure. In particular, the CU 210 may transmit, and the DU 230b may receive, an indication to modify a configuration of the active cell group 2. In particular, the CU 210 may transmit, and the DU 230b may receive, a UE context modification request message (e.g., via an API or via a point-to-point interface) indicated for the DU 230b to modify a configuration of the cell group 2. Based on receiving the UE context setup or modification request message, the DU 230b may modify the configuration of the cell group 2 and transmit, to the CU 210, a UE context modification response message confirming the modification of the configuration of the cell group 2.

At 860, the CU 210 may transmit, to the UE 120 via the DU 230d, an RRC reconfiguration message (e.g., an RRC transfer request message) that indicates for the UE 120 to modify a configuration of the cell group 2, and indicates the modified cell group 2 configuration. The CU 210 may provide an indication of the modification to the cell group 2 via the connection associated with the other active cell group (e.g., the cell group 4). The UE 120 may apply the modification to the configuration of the cell group 2, and may retain the modified configuration for cell group 2 even after the cell group 2 is deactivated (e.g., and the cell group 2 is changed from an active cell group to a candidate cell group).

At 865, the UE 120 may transmit (e.g., via the active cell group 4 associated with the DU 230d) an RRC reconfiguration complete message. That is, the UE 120 may transmit the RRC reconfiguration complete message to the DU 230d, and the DU 230d may transmit the RRC reconfiguration complete message to the CU 210 via an API or via a point-to-point interface. The RRC reconfiguration complete message may correspond to an RRC transfer response message and may indicate that the UE 120 has completed the modification of the cell group 2.

As indicated above, FIG. 8 is provided as an example. Other examples may differ from what is described with respect to FIG. 8.

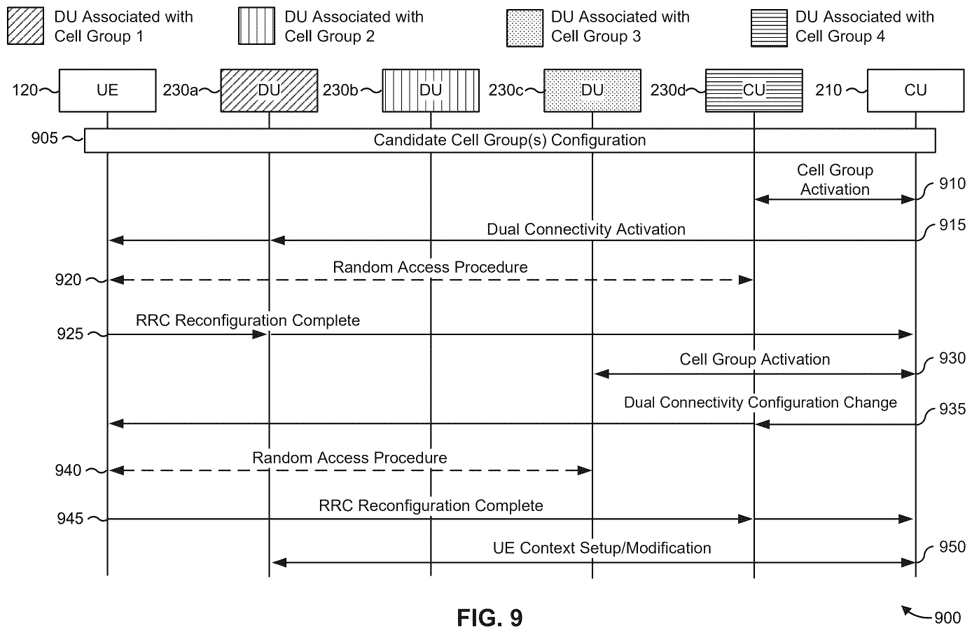

FIG. 9 is a diagram illustrating an example 900 associated with configuring candidate cell groups, in accordance with the present disclosure. As shown in FIG. 9, a UE 120, a DU 230a, a DU 230b, a DU 230c, a DU 230d, and a CU 210 may communicate with one another. The example 900 illustrates one or more operations associated with dual connectivity mobility among candidate cell groups associated with a shared candidate cell group set.

In some cases, a first network node 110 may include the DU 230a, a second network node 110 may include the DU 230b, a third network node may include the DU 230c, a fourth network node 110 may include the DU 230d, and a fifth network node 110 may include the CU 210. Additionally, or alternatively, a single network node 110 may include more than one of the DUs 230 and/or the CU 210. In the example 900, the DU 230a may support a first cell group (e.g., the cell group 1), the DU 230b may support a second cell group (e.g., the cell group 2), the DU 230c may support a third cell group (e.g., the cell group 3), and the DU 230d may support a fourth cell group (e.g., the cell group 4). The CU 210 may correspond to a CU control plane, a service, a connection service, a mobility function, or a mobility service.

The communication between the DUs 230 and the CU 210 may be carried by an API (e.g., a service-based architecture API) or a point-to-point interface. In some cases, the CU-DU communication may be carried by an API when the RRC connection between the UE 120 and the CU 210 corresponds to an association between the UE 120 and the connectivity function based on an identifier shared during an establishment of the association. Additionally, the CU-DU communication may be carried by a point-to-point interface when the RRC connection between the UE 120 and the CU 210 is a point-to-point interface between the UE 120 and the connectivity function.

At 905, the CU 210 may configure one or more candidate cell groups. That is, the UE 120 may be in a connected state and may receive, from the CU 210, a configuration for the candidate cell groups. The cell candidate cell groups may be configured to support dual connectivity of the UE 120, a handover of the UE 120, and/or a conditional handover of the UE 120. In the example 900, the UE 120 may be connected to the CU 210 via the active cell group 1. In this example, the UE 120 may receive the configuration for the candidate cell groups 2, 3, and 4 via the DU 230a. The configuration for the candidate cell groups may configure the cell groups 1, 2, and 3 in one dedicated candidate cell group set, the cell groups 2, 3, and 4 in another dedicated candidate cell group set, and the cell groups 2 and 3 in a shared candidate cell group set.

In some cases, the CU 210 may indicate, to each of the DUs 230 associated with the UE 120, the full UE context. Indicating the full UE context to each of the DUs 230 may enable any of the DUs 230 to perform a context transfer by sending the full UE context to a new CU 210 (e.g., not illustrated in FIG. 9), for example, when a DU 230 loses connectivity with the original CU 210 (e.g., illustrated in FIG. 9). The new CU 210 may then inform the remaining DUs 230 associated with the UE 120 of the CU identifier of the new CU 210.

After configuring the candidate cell groups, the CU 210 may activate a dual connectivity of the UE 120 with the CU 210. In particular, the CU 210 may activate the dual connectivity of the UE 120 via the cell group 1 from the first dedicated cell group set and the cell group 4 from the second dedicated cell group set. The operations associated with activating the dual connectivity of the UE 120 with the CU 210 are described with reference to 910, 915, 920, and 925.

At 910, the CU 210 may perform a cell group activation procedure with the DU 230d. In particular, the CU 210 may transmit, and the DU 230d may receive, a UE context setup or modification request message (e.g., via an API or via a point-to-point interface) indicated for the DU 230d to activate the cell group 4. The UE context setup or modification request message may include an indication of resource activation (e.g., a portion of the L2/L1 resources configured for the cell group 4) for a set of bearers configured for the UE 120. That is, the CU 210 may activate the RLC bearers (e.g., the L2/L1 resources) for the set of bearers on the cell group 4 dynamically. Based on receiving the UE context setup or modification request message, the DU 230d may activate the cell group 4 in accordance with the UE context setup or modification request and transmit, to the CU 210, a UE context setup or modification response message confirming the activation of the cell group 4.

At 915, the CU 210 may transmit, to the UE 120 via the DU 230a, a dual connectivity activation command. In particular, the CU 210 may transmit an RRC reconfiguration message (e.g., an RRC transfer request message) via an API or via a point-to-point interface that indicates for the UE 120 to activate a dual connectivity and indicates a dual connectivity configuration. The dual connectivity configuration may indicate two or more active cell groups for the dual connectivity of the UE 120 with the CU 210. In the example 900, the dual connectivity configuration may indicate for the UE to activate dual connectivity with the CU 210 via the active cell group 1 and the active cell group 4. The dual connectivity configuration may additionally indicate one or more split bearers for the dual connectivity of the UE 120. In some cases, the RRC reconfiguration message may indicate the one or more split bearers based on including one or more SRB identifiers that are split SRBs and one or more DRB identifiers that are split DRBs. Additionally, or alternatively, the RRC reconfiguration message may indicate an active-radio-link control-bearer-per-cell group (e.g., a radio link control bearer logical channel identifier) associated with the split bearer configuration.

At 920, the UE 120 may optionally perform a random access procedure. That is, if the configuration associated with the cell group 4 does not configure an activation procedure of the cell group 4 without performing a random access procedure, the UE 120 may perform the random access procedure with the DU 230d to activate the cell group 4 at 920. Additionally, if the configuration associated with the cell group 4 does configure an activation procedure of the cell group 4 without performing the random access procedure, the UE 120 may refrain from performing the random access procedure with the DU 230d at 920.

At 925, the UE 120 may transmit (e.g., via the active cell group 1 associated with the DU 230a) an RRC reconfiguration complete message. That is, the UE 120 may transmit the RRC reconfiguration complete message to the DU 230a, and the DU 230a may transmit the RRC reconfiguration complete message to the CU 210 via an API or via a point-to-point interface. The RRC reconfiguration complete message may correspond to an RRC transfer response message and may indicate that the UE 120 has completed an activation of the cell group indicated for the UE 120 to activate by the CU 210 at 915. In the example 900, the RRC reconfiguration complete message may indicate that the UE 120 has activated the dual connectivity of the UE 120 via the active cell group 1 and the active cell group 4.

After the UE 120 activates the dual connectivity of the UE 120 via the cell group 1 and the cell group 4, the UE 120 may perform an active cell group change while maintaining the dual connectivity of the UE 120. In particular, the UE 120 may perform a cell group change procedure to change the active cell group 1 with the candidate cell group 2. While FIG. 9 illustrates an example where the CU 210 initiates the cell group change, in other examples a DU 230 may initiate the cell group change or the UE 120 may initiate the cell group change. If a shared candidate cell group is suitable for change of both active cell groups at a same time, then the active cell group for change (e.g., the source cell group) is determined based on one or more parameters. In an example where the cell group change procedure is CU-triggered, the CU may determine the active cell group for change based on a load (e.g., a traffic load associated with the UE 120, with the active cell groups, with the shared candidate cell group), priorities (e.g., of the traffic for the UE 120, of both of the active cell groups, of the shared candidate cell group), or one or more other factors. In an example where the cell group change procedure is DU-triggered, the DU 230 may determine the active cell group for change based on a coordination with the other active DUs 230 (e.g., the DUs 230 that are supporting the other active cell groups), the priorities associated with the active cell groups and/or the priority associated with the candidate cell group, or some other factors. In another example where the cell group change procedure is UE-triggered, the UE 120 may determine the active cell group for change based on one or more conditional criteria (e.g., within the cell group configuration for the candidate cell group) of when the candidate cell group is suitable for the cell group change procedure. The operations associated with this cell group change procedure are described with reference to 930, 935, 940, 945, and 950.

At 930, the CU 210 may transmit, and the DU 230c may receive, an indication to activate the candidate cell group 3. In particular, the CU 210 may transmit, and the DU 230c may receive, a UE context setup or modification request message (e.g., via an API, via a point-to-point interface) indicating for the DU 230c to activate the cell group 3. The UE context setup or modification request message may include an indication of resource activation (e.g., a portion of the L2/L1 resources configured for the cell group 3) for a set of bearers configured for the UE 120. That is, the CU 210 may activate the RLC bearers (e.g., the L2/L1 resources) for the set of bearers on the cell group 3 dynamically. In some cases, the cell group 3 may be initially configured with all of the UE bearers (e.g., based on the cell group 3 being from a shared candidate cell group set). Accordingly, the CU 210 may dynamically indicate a subset or portion of the RLC bearers configured for the cell group 3 that the DU 230c is to activate. Based on receiving the UE context setup or modification request message, the DU 230c may activate the cell group 3 in accordance with the UE context setup or modification request and transmit, to the CU 210, a UE context setup or modification response message confirming the activation of the cell group 3.

At 935, the CU 210 may transmit, to the UE 120 via the DU 230d, a dual connectivity configuration change indication. In one example, the CU 210 may transmit an RRC reconfiguration message (e.g., an RRC transfer request message) via an API or via a point-to-point interface that indicates the dual connectivity configuration change indication. In another example, the CU 210 may transmit lower layer signaling (e.g., for a lower layer triggered mobility procedure, L1 or L2 signaling) that indicates the dual connectivity configuration change indication. The dual connectivity configuration change indication indicates for the UE 120 to change the dual connectivity configuration and indicates the changed dual connectivity configuration. For example, the dual connectivity configuration change indication may indicate for the UE 120 to perform a change procedure from the active cell group 1 to the active cell group 3. In some cases, the dual connectivity configuration change indication may indicate the change procedure based on indicating two or more active cell groups for the dual connectivity of the UE 120 with the CU 210 (e.g., that are different from the current set of active cell groups that are supporting the dual connectivity of the UE 120 with the CU 210). In the example 900, the changed dual connectivity configuration may indicate for the UE 120 to activate dual connectivity with the CU 210 via the active cell group 3 and the active cell group 4.

In some cases, the dual connectivity change indication may indicate for the UE 120 to perform a change procedure that is in accordance with the candidate cell group configurations. For example, the target cell group indicated by the dual connectivity configuration change may be configured as a cell group that supports cell group change procedures from the source cell group indicated by the dual connectivity change indication. In the example 900, the cell group 3 may be configured to support cell group change procedures from the cell group 1 based on the cell group 3 being configured within a shared candidate cell group set.

The dual connectivity change indication may additionally indicate one or more split bearers for the dual connectivity of the UE 120. In some cases, the RRC reconfiguration message may indicate the one or more split bearers based on including one or more SRB identifiers that are split SRBs and one or more DRB identifiers that are split DRBs. Additionally, or alternatively, the RRC reconfiguration message May indicate an active-radio-link control-bearer-per-cell group (e.g., a radio link control-bearer logical channel identifier) associated with the split bearer configuration.

At 940, the UE 120 may optionally perform a random access procedure. That is, if the configuration associated with the cell group 3 does not configure an activation procedure of the cell group 3 without performing a random access procedure, the UE 120 may perform the random access procedure with the DU 230c to activate the cell group 3 at 940. Additionally, if the configuration associated with the cell group 2 does configure an activation procedure of the cell group 3 without performing the random access procedure, the UE 120 may refrain from performing the random access procedure with the DU 230c at 940.

Based on receiving the dual connectivity configuration change indication, the UE 120 may activate the candidate cell group 3 and deactivate the candidate cell group 1. Then, at 945, the UE 120 may transmit (e.g., via the active cell group 4 associated with the DU 230d) an RRC reconfiguration complete message. That is, the UE 120 may transmit the RRC reconfiguration complete message to the DU 230d, and the DU 230d may transmit the RRC reconfiguration complete message to the CU 210 via an API or via a point-to-point interface. The RRC reconfiguration complete message may correspond to an RRC transfer response message and may indicate that the UE 120 has completed the dual connectivity cell group change procedure. In the example 900, the RRC reconfiguration complete message may indicate that the UE 120 has activated the cell group 3 and deactivated the cell group 1.

At 950, the CU 210 may transmit, and the DU 230a may receive, an indication to deactivate the candidate cell group 1. In particular, the CU 210 may transmit, and the DU 230a may receive, a UE context setup or modification request message (e.g., via an API or via a point-to-point interface) indicated for the DU 230a to deactivate the cell group 1. Based on receiving the UE context setup or modification request message, the DU 230a may deactivate the cell group 1 and transmit, to the CU 210, a UE context setup or modification response message confirming the deactivation of the cell group 1.

As indicated above, FIG. 9 is provided as an example. Other examples may differ from what is described with respect to FIG. 9.

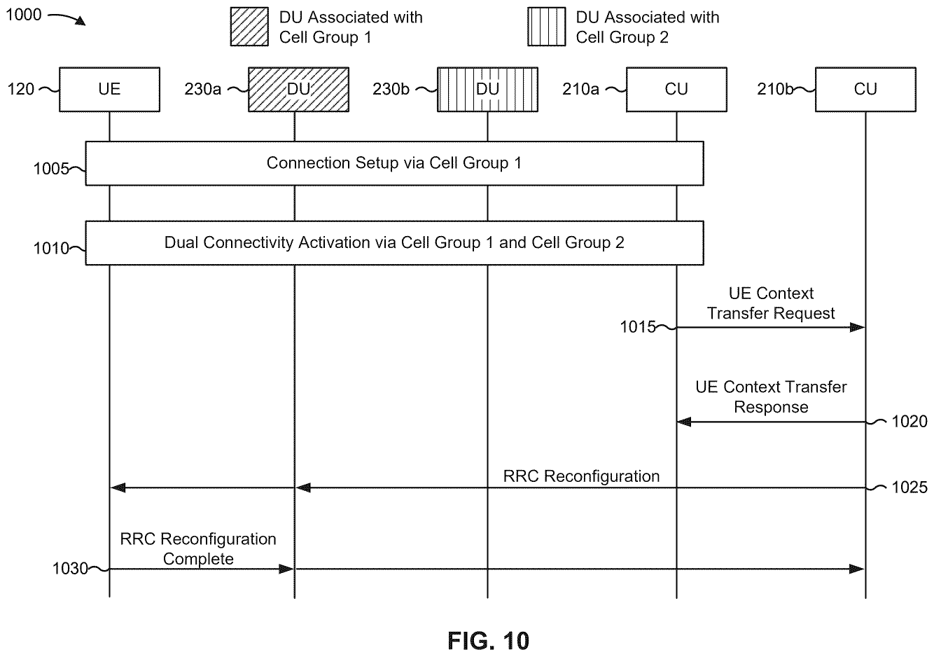

FIG. 10 is a diagram illustrating an example 1000 associated with configuring candidate cell groups, in accordance with the present disclosure. As shown in FIG. 10, a UE 120, a DU 230a, a DU 230b, a DU 230c, a DU 230d, and a CU 210 may communicate with one another. The example 1000 illustrates one or more operations associated with an inter-CU context transfer without changing the active cell groups for a dual connectivity of the UE 120.

In some cases, a first network node 110 may include the DU 230a, a second network node 110 may include the DU 230b, a third network node may include the CU 210a, and a fourth network node 110 may include the CU 210b. Additionally, or alternatively, a single network node 110 may include more than one of the DUs 230 and/or the CUs 210. In the example 1000, the DU 230a may support a first cell group (e.g., the cell group 1) and the DU 230b may support a second cell group (e.g., the cell group 2). The CUs 210 may correspond to a CU control plane, a service, a connection service, a mobility function, or a mobility service.

At 1005, the CU 210a may perform a connection setup procedure with the UE 120 to establish a first connection (e.g., a first RRC connection) with the UE 120 via the cell group 1. Additionally, at 1010, the CU 210a may perform a dual connectivity activation procedure to activate dual connectivity for the UE 120 via the cell group 1 and the cell group 2.

After activating the dual connectivity of the UE 120 via the cell groups 1 and 2, the CU 210a may determine to perform an inter-CU context transfer to switch the anchor CU of the UE 120 from the CU 210a to the CU 210b. In the example 1000, the CUs 210 may perform the inter-CU context transfer independently of any cell group addition, change, or release procedures. In some cases, a CU-control plane may include information about the DUs 230 that are associated with the active cell groups for the UE 120. For example, the CU-control plane may include information corresponding to the DU 230a and the DU 230b. Additionally, the CU-control plane may include information related to the CU-user planes for the UE 120. In some cases, the CU-user planes associated with the UE 120 may be retained during the inter-CU context transfer. In some cases, the UE 120 may not perform a random access procedure as part of the inter-CU context transfer. That is, because the DUs 230 providing the cell groups for the dual connectivity of the UE 120 do not change, the UE 120 may not need to perform any random access procedure as part of the inter-CU context transfer.

At 1015, the CU 210a may transmit, and the CU 210b may receive, a UE context transfer request message (e.g., via an API or via a point-to-point interface). The UE context transfer request message may request for the CU 210a to switch with the CU 210b as the anchor CU for the UE 120. That is, the UE context transfer request may request for the CU 210b to receive the UE context for the UE 120. The UE context transfer request message may include an RRC container with the first cell group configuration including the cell identifier of the first active cell group (e.g., the cell group 1) and a secondary cell group including the cell identifier of the second cell group (e.g., the cell group 2). The cell group identifiers of the first and second cell groups may correspond to a physical cell identifier and/or a cell group identifier. The UE context transfer request message may additionally include a security key. In some examples, the UE context transfer request message may also include an identifier of the DUs 230 that are associated with the cell groups for the UE 120. For example, the UE context transfer request message may include an identifier of the DU 230a and the DU 230b. The identifiers of the DUs 230 may correspond to a location of the DU 230 (e.g., an internet protocol address of the DU 230, a fully qualified domain name associated with the DU 230).

At 1020, the CU 210b may transmit, and the CU 210a may receive (e.g., via an API or via a point-to-point interface), a UE context transfer response message. The UE context transfer response message may confirm that the CU 210b is transferring the UE context associated with the UE 120, and that the CU 210b is the new anchor CU for the UE 120. In some cases, the UE context transfer response message may include an RRC container. Here, the CU 210a may send the RRC container to the UE 120 via the cell group 1 and/or the cell group 2.

At 1025, and after transferring the UE context from the CU 210a to the CU 210b, the CU 210b may transmit, and the UE 120 may receive, an RRC reconfiguration message. The RRC reconfiguration message may include a new security key that is associated with the CU 210b.

At 1030, the UE 120 may transmit, and the CU 210b may receive, an RRC reconfiguration complete message. That is, the UE 120 may transmit the RRC reconfiguration complete message to the DU 230a, and the DU 230a may transmit the RRC reconfiguration complete message to the CU 210b via an API or via a point-to-point interface. The RRC reconfiguration complete message may correspond to an RRC transfer response message and may indicate that the UE 120 has the RRC reconfiguration (e.g., associated with the new security key) indicated at 1025.

As indicated above, FIG. 10 is provided as an example. Other examples may differ from what is described with respect to FIG. 10.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with configuring candidate cell groups.

As shown in FIG. 11, in some aspects, process 1100 may include establishing a dual connection with a network node, the dual connection comprising a first connection via a first cell group and a second connection via a second cell group (block 1110). For example, the UE (e.g., using communication manager 1306, depicted in FIG. 13) may establish a dual connection with a network node, the dual connection comprising a first connection via a first cell group and a second connection via a second cell group, as described above.

As further shown in FIG. 11, in some aspects, process 1100 may include receiving, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group (block 1120). For example, the UE (e.g., using reception component 1302 and/or communication manager 1306, depicted in FIG. 13) may receive, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group, as described above.

As further shown in FIG. 11, in some aspects, process 1100 may include performing a cell group change procedure to change the first cell group to the third cell group based at least in part on the configuration for the third cell group indicating that the third cell group is a candidate for changing the first cell group or for changing the first cell group and the second cell group (block 1130). For example, the UE (e.g., using communication manager 1306, depicted in FIG. 13) may perform a cell group change procedure to change the first cell group to the third cell group based at least in part on the configuration for the third cell group indicating that the third cell group is a candidate for changing the first cell group or for changing the first cell group and the second cell group, as described above.

Process 1100 may include additional aspects, such as any single aspect or any combination of aspects described below and/or in connection with one or more other processes described elsewhere herein.

In a first aspect, the configuration for the third cell group comprises an indication of a set of cell groups for which the third cell group supports cell group change procedures.

In a second aspect, the configuration for the third cell group indicates that the third cell group is the candidate for changing the first cell group, wherein performing the cell group change procedure is based at least in part on the third cell group being the candidate for changing the first cell group and the third cell group not being the candidate for changing the second cell group.

In a third aspect, the configuration for the third cell group indicates that the third cell group is the candidate for changing either the first cell group or the second cell group with the third cell group.

In a fourth aspect, the cell group change procedure is initiated by a central unit associated with the network node, and changing the first cell group is based at least in part on a first load associated with the first cell group, a second load associated with the second cell group, a first priority associated with the first cell group, or a second priority associated with the second cell group.

In a fifth aspect, the cell group change procedure is initiated by a first distributed unit associated with the network node, and changing to the first cell group is based at least in part on a coordination between the first distributed unit and one or more second distributed units associated with the network node, a first priority associated with the first cell group, or a second priority associated with the second cell group.

In a sixth aspect, process 1100 includes determining whether to perform the cell group change procedure from the first cell group or the second cell group, wherein performing the cell group change procedure is based at least in part on determining to perform the cell group change procedure from the first cell group.

In a seventh aspect, determining to perform the cell group change procedure from the cell group is based at least in part on a first priority of a first distributed unit associated with the first cell group, or a second priority of a second distributed unit associated with the second cell group.

In an eighth aspect, the configuration for the third cell group comprises an indication of one or more parameters of the configuration for the third cell group that differ from one or more parameters of a predefined cell group configuration associated with a candidate cell group that is for changing either the first cell group or the second cell group.

In a ninth aspect, process 1100 includes reporting, via the first cell group or the second cell group, one or more measurements associated with the third cell group, wherein the one or more measurements associated with the third cell group are transmitted via the first cell group or the second cell group based at least in part on the third cell group being the candidate for changing either the first cell group or the second cell group, and wherein performing the cell group change procedure is based at least in part on the one or more measurements.

In a tenth aspect, process 1100 includes receiving a command to change the first cell group to the third cell group, wherein performing the cell group change procedure comprises changing the first cell group to the third cell group based at least in part on the command.

In an eleventh aspect, the command comprises an indication of one or more bearers, from a plurality of bearers that are configured for the third cell group by the configuration, that are activated for the third cell group.

In a twelfth aspect, receiving the command comprises receiving a radio resource control reconfiguration message, a MAC-CE, or an L1 command.

In a thirteenth aspect, process 1100 includes determining that a condition associated with performing the cell group change procedure is satisfied, wherein performing the cell group change procedure is responsive to the condition being satisfied.

In a fourteenth aspect, the configuration for the third cell group indicates one or more conditions for performing cell group change procedures to the third cell group, and the one or more conditions comprise the condition associated with performing the cell group change procedure.

In a fifteenth aspect, the configuration for the third cell group indicates a default set of one or more active bearers associated with the third cell group.

In a sixteenth aspect, receiving the configuration for the third cell group comprises receiving one or more radio resource control reconfiguration messages.

In a seventeenth aspect, the configuration for the third cell group indicates one or more SRB configurations for the third cell group and one or more DRB configurations for the third cell group.

In an eighteenth aspect, the configuration for the third cell group configures a plurality of SRBs for the third cell group and a plurality of DRBs for the third cell group, and process 1100 further comprises receiving an indication to activate resources for a first subset of the plurality of SRBs and second subset of the plurality of DRBs based at least in part on performing the cell group change procedure to the third cell group.

In a nineteenth aspect, performing the cell group change procedure comprises establishing a third connection with the network node via the third cell group, and releasing the first connection with the network node via the first cell group based at least in part on establishing the third connection.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with configuring candidate cell groups.

As shown in FIG. 12, in some aspects, process 1200 may include establishing a dual connection with a UE, the dual connection comprising a first connection via a first cell group and a second connection via a second cell group (block 1210). For example, the network node (e.g., using communication manager 1406, depicted in FIG. 14) may establish a dual connection with a UE, the dual connection comprising a first connection via a first cell group and a second connection via a second cell group, as described above.

As further shown in FIG. 12, in some aspects, process 1200 may include transmitting, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group (block 1220). For example, the network node (e.g., using transmission component 1404 and/or communication manager 1406, depicted in FIG. 14) may transmit, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group, as described above.

As further shown in FIG. 12, in some aspects, process 1200 may include performing a cell group change procedure to change the first cell group to the third cell group based at least in part on the configuration for the third cell group indicating that the third cell group is a candidate for changing the first cell group or for changing the first cell group and the second cell group (block 1230). For example, the network node (e.g., using communication manager 1406, depicted in FIG. 14) may perform a cell group change procedure to change the first cell group to the third cell group based at least in part on the configuration for the third cell group indicating that the third cell group is a candidate for changing the first cell group or for changing the first cell group and the second cell group, as described above.

Process 1200 may include additional aspects, such as any single aspect or any combination of aspects described below and/or in connection with one or more other processes described elsewhere herein.

In a first aspect, the configuration for the third cell group comprises an indication of a set of cell groups for which the third cell group supports cell group change procedures.

In a second aspect, the configuration for the third cell group indicates that the third cell group is the candidate for changing the first cell group, wherein performing the cell group change procedure is based at least in part on the third cell group being the candidate for changing the first cell group and the third cell group not being the candidate for changing the second cell group.

In a third aspect, the configuration for the third cell group indicates that the third cell group is the candidate for changing the first cell group and the second cell group.

In a fourth aspect, the cell group change procedure is initiated by a central unit associated with the network node, and changing the first cell group is based at least in part on a first load associated with the first cell group, a second load associated with the second cell group, a first priority associated with the first cell group, or a second priority associated with the second cell group.

In a fifth aspect, the cell group change procedure is initiated by a first distributed unit associated with the network node, and changing to the first cell group is based at least in part on a coordination between the first distributed unit and one or more second distributed units associated with the network node, a first priority associated with the first cell group, or a second priority associated with the second cell group.

In a sixth aspect, the cell group change procedure is initiated by the UE, and changing to the first cell group is based at least in part on a first priority of a first distributed unit associated with the first cell group, or a second priority of a second distributed unit associated with the second cell group.

In a seventh aspect, the configuration for the third cell group comprises an indication of one or more parameters of the configuration for the third cell group that differ from one or more parameters of a predefined cell group configuration associated with a candidate cell group that is for changing either the first cell group or the second cell group.

In an eighth aspect, process 1200 includes receiving, from the UE via the first cell group or the second cell group, one or more measurements associated with the third cell group, wherein the one or more measurements associated with the third cell group are received via the first cell group or the second cell group based at least in part on the third cell group being the candidate for changing either the first cell group or the second cell group, and wherein performing the cell group change procedure is based at least in part on the one or more measurements.

In a ninth aspect, process 1200 includes transmitting, to the UE, a command to change the first cell group to the third cell group, wherein performing the cell group change procedure comprises changing the first cell group to the third cell group based at least in part on the command.

In a tenth aspect, the command comprises an indication of one or more bearers, from a plurality of bearers that are configured for the third cell group by the configuration, that are activated for the third cell group.

In an eleventh aspect, transmitting the command comprises transmitting a radio resource control reconfiguration message, a MAC-CE, or an L1 command.

In a twelfth aspect, the configuration for the third cell group indicates one or more conditions for the UE to trigger cell group change procedures to the third cell group, and performing the cell group change procedure is based at least in part on one of the one or more conditions being satisfied.

In a thirteenth aspect, the configuration for the third cell group indicates a default set of one or more active bearers associated with the third cell group.

In a fourteenth aspect, transmitting the configuration for the third cell group comprises transmitting one or more radio resource control reconfiguration messages.

In a fifteenth aspect, the configuration for the third cell group indicates one or more SRB configurations for the third cell group and one or more DRB configurations for the third cell group.

In a sixteenth aspect, performing the cell group change procedure comprises establishing a third connection with the UE via the third cell group, and releasing the first connection with the network node via the first cell group based at least in part on establishing the third connection.

In a seventeenth aspect, establishing the first connection with the UE via the third cell group comprises communicating, to a first distributed unit associated with the third cell group, a first UE context setup request message or a first UE context modification request message indicating an activation of the third cell group, and releasing the second control connection comprises communicating, to a second distributed unit associated with the first cell group, a second UE context setup request message or a second UE context modification request message indicating a deactivation of the first cell group.

In an eighteenth aspect, the first UE context setup request message or the first UE context modification request message indicates one or more bearers, from a plurality of bearers that are configured for the third cell group by the configuration, that are activated for the third cell group.

In a nineteenth aspect, the network node comprises a first central unit, the process 1200 further comprising transmitting, from the network node to a second network node comprising a second central unit, a request to transfer a context associated with the UE from the first central unit to the second central unit, and receiving, from the second network node, a response indicating a successful transfer of the context associated with the UE to the second central unit.

In a twentieth aspect, the request to transfer the context associated with the UE comprises a first configuration for the first cell group, a second configuration for the third cell group, and a security key for the context associated with the UE.

In a twenty-first aspect, the first configuration for the first cell group comprises a first cell identifier of the first cell group and a first identifier of a first distributed unit associated with the first cell group, and the second configuration for the third cell group comprises a second cell identifier of the third cell group and a second identifier of a second distributed unit associated with the third cell group.

In a twenty-second aspect, process 1200 includes providing, to a first distributed unit associated with the first cell group and to a second distributed unit associated with the second cell group, a context associated with the UE, based at least in part on establishing the dual connection with the UE via the first cell group and the second cell group.

In a twenty-third aspect, the network node comprises a central unit and one or more distributed units.

In a twenty-fourth aspect, the network node comprises a central unit, and establishing the dual connection comprises establishing a first radio resource control connection with the UE via the first cell group and a second network node that comprises a first distributed unit, and establishing a second radio resource control connection with the UE via the second cell group and a third network node that comprises a second distributed unit, and the third cell group is associated with a fourth network node that comprises a third distributed unit.

In a twenty-fifth aspect, the first radio resource control connection and the second radio resource control connection are point-to-point connections between the UE and the network node.

In a twenty-sixth aspect, the first radio resource control connection corresponds to a first association between the UE and the network node that is based at least in part on a first identifier shared between the UE and the network node during an establishment of the first radio resource control connection, and the second radio resource control connection corresponds to a second association between the UE and the network node that is based at least in part on a second identifier shared between the UE and the network node during an establishment of the second radio resource control connection.

In a twenty-seventh aspect, the configuration for the third cell group configures a plurality of SRBs for the third cell group and a plurality of DRBs for the third cell group, and process 1200 further comprises transmitting, based at least in part on the cell group change procedure to the third cell group, an indication for the UE to activate resources for a first subset of the plurality of SRBs and second subset of the plurality of DRBs.

In a twenty-eighth aspect, the network node comprises a central unit, and the central unit is associated with a central unit control plane, a connection service, a mobility function, or a mobility service.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 3-11. Additionally, or alternatively, the apparatus 1300 may be configured to perform one or more processes described herein, such as the process 1100 of FIG. 11. In some aspects, the apparatus 1300 and/or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The communication manager 1306 may establish a dual connection with a network node, the dual connection comprising a first connection via a first cell group and a second connection via a second cell group. The reception component 1302 may receive, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group. The communication manager 1306 may perform a cell group change procedure to change the first cell group to the third cell group based at least in part on the configuration for the third cell group indicating that the third cell group is a candidate for changing the first cell group or for changing the first cell group and the second cell group.

The communication manager 1306 may determine whether to perform the cell group change procedure from the first cell group or the second cell group, wherein performing the cell group change procedure is based at least in part on determining to perform the cell group change procedure from the first cell group.

The communication manager 1306 may report, via the first cell group or the second cell group, one or more measurements associated with the third cell group, wherein the one or more measurements associated with the third cell group are transmitted via the first cell group or the second cell group based at least in part on the third cell group being the candidate for changing either the first cell group or the second cell group, and wherein performing the cell group change procedure is based at least in part on the one or more measurements.

The reception component 1302 may receive a command to change the first cell group to the third cell group, wherein performing the cell group change procedure comprises changing the first cell group to the third cell group based at least in part on the command.

The communication manager 1306 may determine that a condition associated with performing the cell group change procedure is satisfied, wherein performing the cell group change procedure is responsive to the condition being satisfied.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the network node.

In some aspects, the apparatus 1400 may be configured to perform one or more operations described herein in connection with FIGS. 3-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network node described above in connection with FIG. 1, such as a radio, one or more RF chains, one or more transceivers, or one or more modems, each of which may in turn be coupled with one or more antennas of the network node. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1404 may be co-located with the reception component 1402.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The communication manager 1406 may establish a dual connection with a UE, the dual connection comprising a first connection via a first cell group and a second connection via a second cell group. The transmission component 1404 may transmit, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group. The communication manager 1406 may perform a cell group change procedure to change the first cell group to the third cell group based at least in part on the configuration for the third cell group indicating that the third cell group is a candidate for changing the first cell group or for changing the first cell group and the second cell group.

The reception component 1402 may receive, from the UE via the first cell group or the second cell group, one or more measurements associated with the third cell group, wherein the one or more measurements associated with the third cell group are received via the first cell group or the second cell group based at least in part on the third cell group being the candidate for changing either the first cell group or the second cell group, and wherein performing the cell group change procedure is based at least in part on the one or more measurements.

The transmission component 1404 may transmit, to the UE, a command to change the first cell group to the third cell group, wherein performing the cell group change procedure comprises changing the first cell group to the third cell group based at least in part on the command.

The communication manager 1406 may establish the first connection with the UE via the third cell group by communicating, to a first distributed unit associated with the third cell group, a first UE context setup request message or a first UE context modification request message indicating an activation of the third cell group.

The communication manager 1406 may release the second control connection by communicating, to a second distributed unit associated with the first cell group, a second UE context setup request message or a second UE context modification request message indicating a deactivation of the first cell group.

The communication manager 1406 may provide, to a first distributed unit associated with the first cell group and to a second distributed unit associated with the second cell group, a context associated with the UE, based at least in part on establishing the dual connection with the UE via the first cell group and the second cell group.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a UE, comprising: establishing a dual connection with a network node, the dual connection comprising a first connection via a first cell group and a second connection via a second cell group; receiving, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group; and performing a cell group change procedure to change the first cell group to the third cell group based at least in part on the configuration for the third cell group indicating that the third cell group is a candidate for changing the first cell group or for changing the first cell group and the second cell group.

Aspect 2: The method of Aspect 1, wherein the configuration for the third cell group comprises an indication of a set of cell groups for which the third cell group supports cell group change procedures.

Aspect 3: The method of any of Aspects 1-2, wherein the configuration for the third cell group indicates that the third cell group is the candidate for changing the first cell group, wherein performing the cell group change procedure is based at least in part on the third cell group being the candidate for changing the first cell group and the third cell group not being the candidate for changing the second cell group.

Aspect 4: The method of any of Aspects 1-3, wherein the configuration for the third cell group indicates that the third cell group is the candidate for changing either the first cell group or the second cell group with the third cell group.

Aspect 5: The method of Aspect 4, wherein: the cell group change procedure is initiated by a central unit associated with the network node; and changing the first cell group is based at least in part on a first load associated with the first cell group, a second load associated with the second cell group, a first priority associated with the first cell group, or a second priority associated with the second cell group.

Aspect 6: The method of Aspect 4, wherein: the cell group change procedure is initiated by a first distributed unit associated with the network node; and changing to the first cell group is based at least in part on a coordination between the first distributed unit and one or more second distributed units associated with the network node, a first priority associated with the first cell group, or a second priority associated with the second cell group.

Aspect 7: The method of Aspect 4, further comprising: determining whether to perform the cell group change procedure from the first cell group or the second cell group, wherein performing the cell group change procedure is based at least in part on determining to perform the cell group change procedure from the first cell group.

Aspect 8: The method of Aspect 7, wherein determining to perform the cell group change procedure from the cell group is based at least in part on a first priority of a first distributed unit associated with the first cell group, or a second priority of a second distributed unit associated with the second cell group.

Aspect 9: The method of Aspect 4, wherein the configuration for the third cell group comprises an indication of one or more parameters of the configuration for the third cell group that differ from one or more parameters of a predefined cell group configuration associated with a candidate cell group that is for changing either the first cell group or the second cell group.

Aspect 10: The method of Aspect 4, further comprising: reporting, via the first cell group or the second cell group, one or more measurements associated with the third cell group, wherein the one or more measurements associated with the third cell group are transmitted via the first cell group or the second cell group based at least in part on the third cell group being the candidate for changing either the first cell group or the second cell group, and wherein performing the cell group change procedure is based at least in part on the one or more measurements.

Aspect 11: The method of any of Aspects 1-10, further comprising: receiving a command to change the first cell group to the third cell group, wherein performing the cell group change procedure comprises changing the first cell group to the third cell group based at least in part on the command.

Aspect 12: The method of Aspect 11, wherein the command comprises an indication of one or more bearers, from a plurality of bearers that are configured for the third cell group by the configuration, that are activated for the third cell group.

Aspect 13: The method of Aspect 11, wherein receiving the command comprises receiving a radio resource control reconfiguration message, a MAC-CE, or an L1 command.

Aspect 14: The method of any of Aspects 1-13, further comprising: determining that a condition associated with performing the cell group change procedure is satisfied, wherein performing the cell group change procedure is responsive to the condition being satisfied.

Aspect 15: The method of Aspect 14, wherein: the configuration for the third cell group indicates one or more conditions for performing cell group change procedures to the third cell group; and the one or more conditions comprise the condition associated with performing the cell group change procedure.

Aspect 16: The method of Aspect 14, wherein the configuration for the third cell group indicates a default set of one or more active bearers associated with the third cell group.

Aspect 17: The method of any of Aspects 1-16, wherein receiving the configuration for the third cell group comprises receiving one or more radio resource control reconfiguration messages.

Aspect 18: The method of any of Aspects 1-17, wherein the configuration for the third cell group indicates one or more SRB configurations for the third cell group and one or more DRB configurations for the third cell group.

Aspect 19: The method of any of Aspects 1-18, wherein: the configuration for the third cell group configures a plurality of SRBs for the third cell group and a plurality of DRBs for the third cell group; and the method further comprises receiving an indication to activate resources for a first subset of the plurality of SRBs and second subset of the plurality of DRBs based at least in part on performing the cell group change procedure to the third cell group.

Aspect 20: The method of any of Aspects 1-19, wherein performing the cell group change procedure comprises: establishing a third connection with the network node via the third cell group; and releasing the first connection with the network node via the first cell group based at least in part on establishing the third connection.

Aspect 21: A method of wireless communication performed by a network node, comprising: establishing a dual connection with a UE, the dual connection comprising a first connection via a first cell group and a second connection via a second cell group; transmitting, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group; and performing a cell group change procedure to change the first cell group to the third cell group based at least in part on the configuration for the third cell group indicating that the third cell group is a candidate for changing the first cell group or for changing the first cell group and the second cell group.

Aspect 22: The method of Aspect 21, wherein the configuration for the third cell group comprises an indication of a set of cell groups for which the third cell group supports cell group change procedures.

Aspect 23: The method of any of Aspects 21-22, wherein the configuration for the third cell group indicates that the third cell group is the candidate for changing the first cell group, wherein performing the cell group change procedure is based at least in part on the third cell group being the candidate for changing the first cell group and the third cell group not being the candidate for changing the second cell group.

Aspect 24: The method of any of Aspects 21-23, wherein the configuration for the third cell group indicates that the third cell group is the candidate for changing the first cell group and the second cell group.

Aspect 25: The method of Aspect 24, wherein: the cell group change procedure is initiated by a central unit associated with the network node; and changing the first cell group is based at least in part on a first load associated with the first cell group, a second load associated with the second cell group, a first priority associated with the first cell group, or a second priority associated with the second cell group.

Aspect 26: The method of Aspect 24, wherein: the cell group change procedure is initiated by a first distributed unit associated with the network node; and changing to the first cell group is based at least in part on a coordination between the first distributed unit and one or more second distributed units associated with the network node, a first priority associated with the first cell group, or a second priority associated with the second cell group.

Aspect 27: The method of Aspect 24, wherein: the cell group change procedure is initiated by the UE; and changing to the first cell group is based at least in part on a first priority of a first distributed unit associated with the first cell group, or a second priority of a second distributed unit associated with the second cell group.

Aspect 28: The method of Aspect 24, wherein the configuration for the third cell group comprises an indication of one or more parameters of the configuration for the third cell group that differ from one or more parameters of a predefined cell group configuration associated with a candidate cell group that is for changing either the first cell group or the second cell group.

Aspect 29: The method of Aspect 24, further comprising: receiving, from the UE via the first cell group or the second cell group, one or more measurements associated with the third cell group, wherein the one or more measurements associated with the third cell group are received via the first cell group or the second cell group based at least in part on the third cell group being the candidate for changing either the first cell group or the second cell group, and wherein performing the cell group change procedure is based at least in part on the one or more measurements.

Aspect 30: The method of any of Aspects 21-29, further comprising: transmitting, to the UE, a command to change the first cell group to the third cell group, wherein performing the cell group change procedure comprises changing the first cell group to the third cell group based at least in part on the command.

Aspect 31: The method of Aspect 30, wherein the command comprises an indication of one or more bearers, from a plurality of bearers that are configured for the third cell group by the configuration, that are activated for the third cell group.

Aspect 32: The method of Aspect 30, wherein transmitting the command comprises transmitting a radio resource control reconfiguration message, a MAC-CE, or an L1 command.

Aspect 33: The method of any of Aspects 21-32, wherein: the configuration for the third cell group indicates one or more conditions for the UE to trigger cell group change procedures to the third cell group; and performing the cell group change procedure is based at least in part on one of the one or more conditions being satisfied.

Aspect 34: The method of Aspect 33, wherein the configuration for the third cell group indicates a default set of one or more active bearers associated with the third cell group.

Aspect 35: The method of any of Aspects 21-34, wherein transmitting the configuration for the third cell group comprises transmitting one or more radio resource control reconfiguration messages.

Aspect 36: The method of any of Aspects 21-35, wherein the configuration for the third cell group indicates one or more SRB configurations for the third cell group and one or more DRB configurations for the third cell group.

Aspect 37: The method of any of Aspects 21-36, wherein performing the cell group change procedure comprises: establishing a third connection with the UE via the third cell group; and releasing the first connection with the network node via the first cell group based at least in part on establishing the third connection.

Aspect 38: The method of Aspect 37, wherein: establishing the first connection with the UE via the third cell group comprises communicating, to a first distributed unit associated with the third cell group, a first UE context setup request message or a first UE context modification request message indicating an activation of the third cell group; and releasing the second control connection comprises communicating, to a second distributed unit associated with the first cell group, a second UE context setup request message or a second UE context modification request message indicating a deactivation of the first cell group.

Aspect 39: The method of Aspect 38, wherein the first UE context setup request message or the first UE context modification request message indicates one or more bearers, from a plurality of bearers that are configured for the third cell group by the configuration, that are activated for the third cell group.

Aspect 40: The method of any of Aspects 21-39, wherein the network node comprises a first central unit, the method further comprising: transmitting, from the network node to a second network node comprising a second central unit, a request to transfer a context associated with the UE from the first central unit to the second central unit; and receiving, from the second network node, a response indicating a successful transfer of the context associated with the UE to the second central unit.

Aspect 41: The method of Aspect 40, wherein the request to transfer the context associated with the UE comprises a first configuration for the first cell group, a second configuration for the third cell group, and a security key for the context associated with the UE.

Aspect 42: The method of Aspect 41, wherein: the first configuration for the first cell group comprises a first cell identifier of the first cell group and a first identifier of a first distributed unit associated with the first cell group; and the second configuration for the third cell group comprises a second cell identifier of the third cell group and a second identifier of a second distributed unit associated with the third cell group.

Aspect 43: The method of any of Aspects 21-42, further comprising: providing, to a first distributed unit associated with the first cell group and to a second distributed unit associated with the second cell group, a context associated with the UE, based at least in part on establishing the dual connection with the UE via the first cell group and the second cell group.

Aspect 44: The method of any of Aspects 21-43, wherein the network node comprises a central unit and one or more distributed units.

Aspect 45: The method of any of Aspects 21-44, wherein the network node comprises a central unit, and establishing the dual connection comprises: establishing a first radio resource control connection with the UE via the first cell group and a second network node that comprises a first distributed unit, and establishing a second radio resource control connection with the UE via the second cell group and a third network node that comprises a second distributed unit; and the third cell group is associated with a fourth network node that comprises a third distributed unit.

Aspect 46: The method of Aspect 45, wherein the first radio resource control connection and the second radio resource control connection are point-to-point connections between the UE and the network node.

Aspect 47: The method of Aspect 45, wherein: the first radio resource control connection corresponds to a first association between the UE and the network node that is based at least in part on a first identifier shared between the UE and the network node during an establishment of the first radio resource control connection; and the second radio resource control connection corresponds to a second association between the UE and the network node that is based at least in part on a second identifier shared between the UE and the network node during an establishment of the second radio resource control connection.

Aspect 48: The method of any of Aspects 21-47, wherein: the configuration for the third cell group configures a plurality of SRBs for the third cell group and a plurality of DRBs for the third cell group; and the method further comprises transmitting, based at least in part on the cell group change procedure to the third cell group, an indication for the UE to activate resources for a first subset of the plurality of SRBs and second subset of the plurality of DRBs.

Aspect 49: The method of any of Aspects 21-48, wherein: the network node comprises a central unit; and the central unit is associated with a central unit control plane, a connection service, a mobility function, or a mobility service.

Aspect 50: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-49.

Aspect 51: An apparatus for wireless communication at a device, the apparatus comprising one or more memories and one or more processors coupled to the one or more memories, the one or more processors configured to cause the device to perform the method of one or more of Aspects 1-49.

Aspect 52: An apparatus for wireless communication, the apparatus comprising at least one means for performing the method of one or more of Aspects 1-49.

Aspect 53: A non-transitory computer-readable medium storing code for wireless communication, the code comprising instructions executable by one or more processors to perform the method of one or more of Aspects 1-49.

Aspect 54: A non-transitory computer-readable medium storing a set of instructions for wireless communication, the set of instructions comprising one or more instructions that, when executed by one or more processors of a device, cause the device to perform the method of one or more of Aspects 1-49.

Aspect 55: A device for wireless communication, the device comprising a processing system that includes one or more processors and one or more memories coupled with the one or more processors, the processing system configured to cause the device to perform the method of one or more of Aspects 1-49.

Aspect 56: An apparatus for wireless communication at a device, the apparatus comprising one or more memories and one or more processors coupled to the one or more memories, the one or more processors individually or collectively configured to cause the device to perform the method of one or more of Aspects 1-49.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled to the one or more memories, the one or more processors individually or collectively configured to:
establish a dual connection with a network node, the dual connection comprising a first connection via a first cell group and a second connection via a second cell group;
receive, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group; and
perform a cell group change procedure to change the first cell group to the third cell group based at least in part on the configuration for the third cell group indicating that the third cell group is a candidate for changing the first cell group or for changing the first cell group and the second cell group.

2. The apparatus of claim 1, wherein the configuration for the third cell group comprises an indication of a set of cell groups for which the third cell group supports cell group change procedures.

3. The apparatus of claim 1, wherein the configuration for the third cell group indicates that the third cell group is the candidate for changing the first cell group, wherein performing the cell group change procedure is based at least in part on the third cell group being the candidate for changing the first cell group and the third cell group not being the candidate for changing the second cell group.

4. The apparatus of claim 1, wherein the configuration for the third cell group indicates that the third cell group is the candidate for changing either the first cell group or the second cell group with the third cell group.

5. The apparatus of claim 4, wherein:
the cell group change procedure is initiated by a central unit associated with the network node; and
changing the first cell group is based at least in part on a first load associated with the first cell group, a second load associated with the second cell group, a first priority associated with the first cell group, or a second priority associated with the second cell group.

6. The apparatus of claim 4, wherein:
the cell group change procedure is initiated by a first distributed unit associated with the network node; and
changing to the first cell group is based at least in part on a coordination between the first distributed unit and one or more second distributed units associated with the network node, a first priority associated with the first cell group, or a second priority associated with the second cell group.

7. The apparatus of claim 4, wherein the one or more processors are further configured to:
determine whether to perform the cell group change procedure from the first cell group or the second cell group, wherein performing the cell group change procedure is based at least in part on determining to perform the cell group change procedure from the first cell group.

8. The apparatus of claim 7, wherein determining to perform the cell group change procedure from the cell group is based at least in part on a first priority of a first distributed unit associated with the first cell group, or a second priority of a second distributed unit associated with the second cell group.

9. The apparatus of claim 4, wherein the configuration for the third cell group comprises an indication of one or more parameters of the configuration for the third cell group that differ from one or more parameters of a predefined cell group configuration associated with a candidate cell group that is for changing either the first cell group or the second cell group.

10. The apparatus of claim 4, wherein the one or more processors are further configured to:
report, via the first cell group or the second cell group, one or more measurements associated with the third cell group, wherein the one or more measurements associated with the third cell group are transmitted via the first cell group or the second cell group based at least in part on the third cell group being the candidate for changing either the first cell group or the second cell group, and wherein performing the cell group change procedure is based at least in part on the one or more measurements.

11. The apparatus of claim 1, wherein the one or more processors are further configured to:
receive a command to change the first cell group to the third cell group, wherein performing the cell group change procedure comprises changing the first cell group to the third cell group based at least in part on the command.

12. The apparatus of claim 11, wherein the command comprises an indication of one or more bearers, from a plurality of bearers that are configured for the third cell group by the configuration, that are activated for the third cell group.

13. The apparatus of claim 11, wherein the one or more processors configured to receive the command are further configured to receive a radio resource control reconfiguration message, a medium access control-control element (MAC-CE), or a layer 1 (L1) command.

14. The apparatus of claim 1, wherein the one or more processors are further configured to:
determine that a condition associated with performing the cell group change procedure is satisfied, wherein performing the cell group change procedure is responsive to the condition being satisfied.

15. The apparatus of claim 14, wherein:
the configuration for the third cell group indicates one or more conditions for performing cell group change procedures to the third cell group; and
the one or more conditions comprise the condition associated with performing the cell group change procedure.

16. The apparatus of claim 14, wherein the configuration for the third cell group indicates a default set of one or more active bearers associated with the third cell group.

17. The apparatus of claim 1, wherein to receive the configuration for the third cell group, the one or more processors are configured to receive one or more radio resource control reconfiguration messages.

18. The apparatus of claim 1, wherein the configuration for the third cell group indicates one or more signaling radio bearer configurations for the third cell group and one or more data radio bearer configurations for the third cell group.

19. The apparatus of claim 1, wherein:
the configuration for the third cell group configures a plurality of signaling radio bearers for the third cell group and a plurality of data radio bearers for the third cell group; and
the one or more processors are further configured to receive an indication to activate resources for a first subset of the plurality of signaling radio bearers and second subset of the plurality of data radio bearers based at least in part on performing the cell group change procedure to the third cell group.

20. The apparatus of claim 1, wherein to perform the cell group change procedure, the one or more processors are configured to:
establish a third connection with the network node via the third cell group; and
release the first connection with the network node via the first cell group based at least in part on establishing the third connection.

21. An apparatus for wireless communication at a network node, comprising:
one or more memories; and
one or more processors, coupled to the one or more memories, configured to:
establish a dual connection with a user equipment (UE), the dual connection comprising a first connection via a first cell group and a second connection via a second cell group;
transmit, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group; and
perform a cell group change procedure to change the first cell group to the third cell group based at least in part on the configuration for the third cell group indicating that the third cell group is a candidate for changing the first cell group or for changing the first cell group and the second cell group.

22. The apparatus of claim 21, wherein the configuration for the third cell group indicates that the third cell group is the candidate for changing the first cell group and the second cell group.

23. The apparatus of claim 21, wherein the one or more processors are further configured to:
transmit, to the UE, a command to change the first cell group to the third cell group, wherein performing the cell group change procedure comprises changing the first cell group to the third cell group based at least in part on the command.

24. The apparatus of claim 21, wherein the network node comprises a first central unit, and wherein the one or more processors are further configured to:
transmit, from the network node to a second network node comprising a second central unit, a request to transfer a context associated with the UE from the first central unit to the second central unit; and
receive, from the second network node, a response indicating a successful transfer of the context associated with the UE to the second central unit.

25. The apparatus of claim 24, wherein the request to transfer the context associated with the UE comprises a first configuration for the first cell group, a second configuration for the third cell group, and a security key for the context associated with the UE.

26. The apparatus of claim 25, wherein:
the first configuration for the first cell group comprises a first cell identifier of the first cell group and a first identifier of a first distributed unit associated with the first cell group; and
the second configuration for the third cell group comprises a second cell identifier of the third cell group and a second identifier of a second distributed unit associated with the third cell group.

27. The apparatus of claim 21, wherein the one or more processors are further configured to:
provide, to a first distributed unit associated with the first cell group and to a second distributed unit associated with the second cell group, a context associated with the UE, based at least in part on establishing the dual connection with the UE via the first cell group and the second cell group.

28. The apparatus of claim 21, wherein:
the network node comprises a central unit;
to establish the dual connection, the one or more processors are configured to:
establish a first radio resource control connection with the UE via the first cell group and a second network node that comprises a first distributed unit, and
establish a second radio resource control connection with the UE via the second cell group and a third network node that comprises a second distributed unit; and
the third cell group is associated with a fourth network node that comprises a third distributed unit.

29. A method of wireless communication performed by a user equipment (UE), comprising:
establishing a dual connection with a network node, the dual connection comprising a first connection via a first cell group and a second connection via a second cell group;
receiving, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group; and
performing a cell group change procedure to change the first cell group to the third cell group based at least in part on the configuration for the third cell group indicating that the third cell group is a candidate for changing the first cell group or for changing the first cell group and the second cell group.

30. A method of wireless communication performed by a network node, comprising:
establishing a dual connection with a user equipment (UE), the dual connection comprising a first connection via a first cell group and a second connection via a second cell group;
transmitting, via at least one of the first connection or the second connection, a configuration for a third cell group, wherein the configuration for the third cell group indicates whether the third cell group is a candidate for changing the first cell group, for changing the second cell group, or for changing either the first cell group or the second cell group with the third cell group; and
performing a cell group change procedure to change the first cell group to the third cell group based at least in part on the configuration for the third cell group indicating that the third cell group is a candidate for changing the first cell group or for changing the first cell group and the second cell group.
